(19) United States
(12) Patent Application Publication
(10) Pub. No.: US 2024/0303638 A1
(43) Pub. Date: Sep. 12, 2024

(54) SYSTEMS AND METHODS FOR SECURE AUTHENTICATION OF CONTACTLESS CARD

(71) Applicant: Capital One Services, LLC, McLean, VA (US)

(72) Inventors: Kevin OSBORN, Newton Highlands, MA (US); Jeffrey RULE, Chevy Chase, MD (US)

(21) Appl. No.: 18/118,840

(22) Filed: Mar. 8, 2023

(51) Int. Cl. G06Q 20/38; G06Q 20/32; G06Q 20/34; H04L 9/08; H04L 9/32

(52) U.S. Cl. CPC G06Q 20/382; G06Q 20/322; G06Q 20/3278; G06Q 20/352; H04L 9/083; H04L 9/3271; H04L 2209/56

(57) ABSTRACT

A secure authentication system is provided comprising a server including a processor and a memory. The server is configured to: generate an authentication challenge; store the authentication challenge in the memory; transmit the authentication challenge to a user device; generate a session key based on a master key; store the session key in the memory; receive from the user device, an encrypted message authentication code (MAC) cryptogram incorporating the authentication challenge; decrypt the encrypted MAC cryptogram using one or more cryptographic algorithms and the session key; and validate the authentication challenge received from the user device.

### FIELD OF THE INVENTION

The present disclosure relates to cryptography, and more particularly, to systems and methods for the secure authentication of contactless cards.

### BACKGROUND

Data security and transaction integrity are of critical importance to businesses and consumers. This need continues to grow as electronic transactions constitute an increasingly large share of commercial activity.

Email may be used as a tool to verify transactions, but email is susceptible to attack and vulnerable to hacking or other unauthorized access. Short message service (SMS) messages may also be used, but that is subject to compromise as well. Moreover, even data encryption algorithms, such as triple DES algorithms, have similar vulnerabilities.

While the growing use of chip-based financial cards provides more secure features over the previous technology (e.g., magnetic strip cards) for in-person or online purchases, account access still may rely on log-in credentials (e.g., username and password) to confirm a cardholder's identity. However, if the log-in credentials are compromised, another person could have access to the user's account. Further, some contactless cards may be read-only cards, which can expose to potential replay attacks where a fraudster could gather the messages from the contactless cards at one location and then play them back through another channel.

These and other deficiencies exist. Accordingly, there is a need to provide users with an appropriate solution that overcomes these deficiencies to provide data security, authentication, and verification for contactless cards.

### SUMMARY

Aspects of the disclosed technology include systems and methods for secure authentication of contactless cards. Various embodiments describe systems and methods for implementing and managing secure authentication of contactless cards.

Embodiments of the present disclosure provide a secure authentication system. The system may comprise: a server including a processor and a memory. The server is configured to: generate an authentication challenge; store the authentication challenge in the memory; transmit the authentication challenge to a user device; generate a session key based on a master key; store the session key in the memory; receive from the user device, an encrypted message authentication code (MAC) cryptogram incorporating the authentication challenge; decrypt the encrypted MAC cryptogram using one or more cryptographic algorithms and the session key; and validate the authentication challenge received from the user device.

Embodiments of the present disclosure provide a secure authentication system. The system may comprise a user device including a processor and a memory. The user device is configured to: receive from a server, an authentication challenge; transmit, to a contactless card, the authentication challenge; receive from the contactless card, an encrypted MAC cryptogram; and transmit to the server, the encrypted MAC cryptogram.

Embodiments of the present disclosure provide a contactless card. The contactless card may comprise: a memory containing a counter value and a card key; a communication interface; and a processor in communication with the memory and communication interface. The processors is configured to: receive an authentication challenge from a user device when the communication interface is within a range of a communication field of the user device, create an encrypted MAC cryptogram using the card key, the authentication challenge, and the counter value, and transmit the encrypted MAC cryptogram, via the communication interface, to the user device.

Further features of the disclosed invention, and the advantages offered thereby, are explained in greater detail hereinafter with reference to specific example embodiments illustrated in the accompanying drawings, wherein like elements are indicated be like reference designators.

### BRIEF DESCRIPTION OF THE DRAWINGS

FIG. 1 is a diagram of a secure authentication system for a contactless card according to an example embodiment.

FIG. 2 is a diagram illustrating a sequence for providing authenticated access according to an example embodiment.

FIG. 3 is a diagram of a data transmission system according to an example embodiment.

FIG. 4 is a diagram of a system using a contactless card according to an example embodiment.

FIG. 5 is a flowchart illustrating a method of key diversification according to an example embodiment.

FIG. 6A is an illustration of a contactless card according to an example embodiment.

FIG. 6B is an illustration of a contact pad of the contactless card according to an example embodiment.

FIG. 7 is an illustration depicting a message to communicate with a device according to an example embodiment.

FIG. 8 is an illustration depicting a message and a message format according to an example embodiment.

FIG. 9 is a flowchart illustrating key operations according to an example embodiment.

FIG. 10 is a diagram of a key system according to an example embodiment.

FIG. 11 is a flowchart of a method of generating a cryptogram according to an example embodiment.

FIG. 12 is a flowchart illustrating a process of key diversification according to an example embodiment.

FIG. 13 is a flowchart illustrating a method for secure authentication of a contactless card according to an example embodiment.

FIG. 14 is a flowchart illustrating a method for secure authentication of a contactless card according to an example embodiment.

FIG. 15 is a flowchart illustrating a method for secure authentication of a contactless card, which can be executed by a server, according to an example embodiment.

FIG. 16 is a flowchart illustrating a method for secure authentication of a contactless card, which can be executed by a user device, according to an example embodiment.

FIG. 17 is a flowchart illustrating a method for secure authentication of a contactless card, which can be executed by a contactless card, according to an example embodiment.

### DETAILED DESCRIPTION OF EXAMPLE EMBODIMENTS

The following description of embodiments provides non-limiting representative examples referencing numerals to particularly describe features and teachings of different aspects of the invention. The embodiments described are recognized by a person of ordinary skill in the art as capable of implementation separately, or in combination, with other embodiments from the description of the embodiments and the features and teachings of any embodiment can be interchangeably combined with the features and teachings of any other embodiment. A person of ordinary skill in the art reviewing the description of embodiments will be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

An objective of some embodiments of the present disclosure is to build one or more keys into one or more contactless cards. In these embodiments, a contactless card can perform authentication and numerous other functions that may otherwise require a user to carry a separate physical token in addition to the contactless card. By employing a contactless interface, the contactless card may be provided with a method to interact and communicate between a user's device (such as a mobile phone) and the card itself. For example, the EMV protocol, which underlies many credit card transactions, includes an authentication process which suffices for operating systems for Android® but presents challenges for iOS®, which is more restrictive regarding near field communication (NFC) usage, as it can be used only in a read-only manner. Exemplary embodiments of the contactless cards described herein utilize NFC technology.

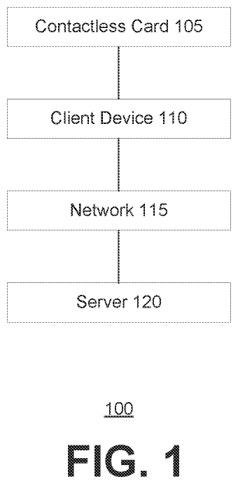

FIG. 1 illustrates a secure authentication system 100 of a contactless card according to an example embodiment. As further discussed below, the system 100 may include a contactless card 105, a client device 110, a network 115, and a server 120. Although FIG. 1 illustrates single instances of the components, the system 100 may include any number of components. In the present disclosure, a contactless card may also be referred to as a first device, and a client/user device may also be referred to as a second device.

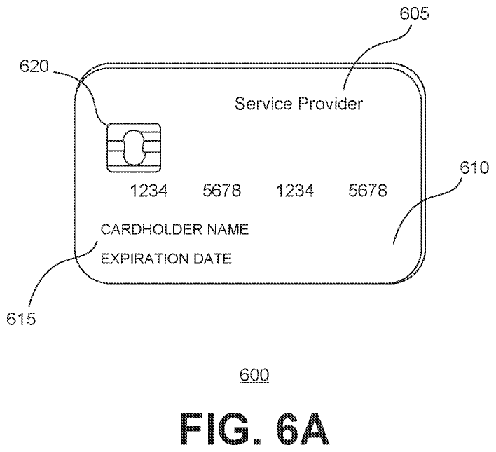

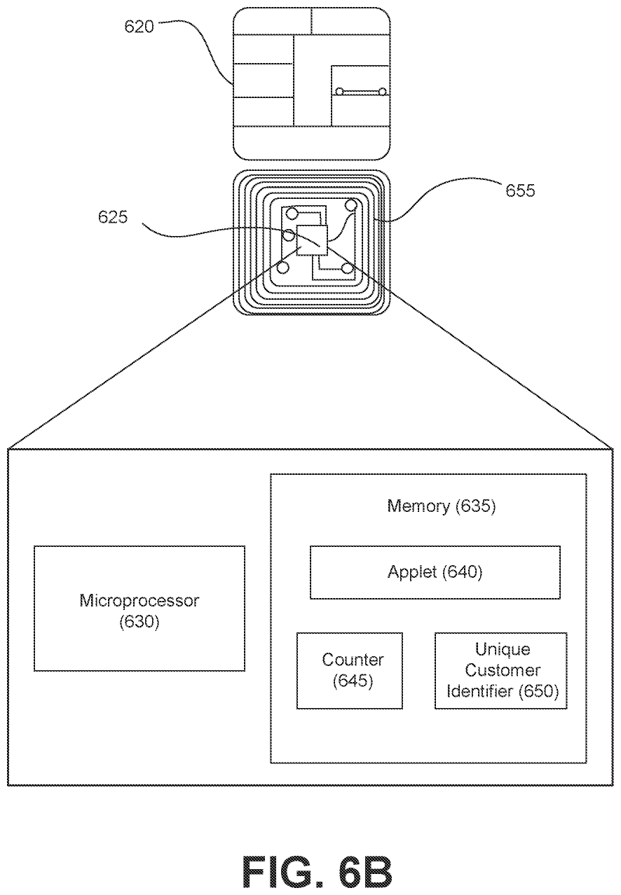

The system 100 may include one or more contactless cards 105, which are further explained below with reference to FIGS. 6A-6B. In some embodiments, the contactless card 105 may be in wireless communication, utilizing NFC in an example, with the client device 110.

The client device 110 may be a network-enabled computer. As referred to herein, a network-enabled computer may include, but is not limited to a computer device, or communications device including, e.g., a server, a network appliance, a personal computer, a workstation, a phone, a handheld PC, a personal digital assistant, a thin client, a fat client, an Internet browser, or other device. The client device 110 may also be a mobile device; for example, an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The client device 110 device can include a processor and a memory. The processor and/or memory may comprise processing circuitry, and it is understood that the processing circuitry may contain additional components, including processors, memories, error and parity/CRC checkers, data encoders, anticollision algorithms, controllers, command decoders, security primitives and tamperproofing hardware, as necessary to perform the functions described herein. The client device 110 may further include a display and input devices. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the client's device that is available and supported by the client's device, such as a touch-screen, keyboard, mouse, cursor-control device, touch-screen, microphone, digital camera, video recorder or camcorder. These input devices may be used to enter information and interact with the software and other devices described herein.

In some examples, the client device 110 may execute one or more applications, such as software applications, that enable, for example, network communications with one or more components of the system 100 and transmit and/or receive data.

The client device 110 may be in communication with one or more servers 120 via one or more networks 115, and may operate as a respective front-end to back-end pair with the server 120. The client device 110 may transmit, for example from a mobile device application executing on the client device 110, one or more requests to the server 120. The one or more requests may be associated with retrieving data from the server 120 and/or authenticating data by the server 120. The server 120 may receive the one or more requests from the client device 110. Based on the one or more requests from the client device 110, the server 120 may be configured to retrieve the requested data from one or more databases (not shown). Based on receipt of the requested data from the one or more databases, the server 120 may be configured to transmit the received data to the client device 110, the received data being responsive to one or more requests. Based on receipt of the requested data from the one or more databases, the server 120 may further be configured to authenticate/verify the requested data.

The system 100 may include one or more networks 115. In some examples, the network 115 may be one or more of a wireless network, a wired network or any combination of wireless network and wired network, and may be configured to connect the client device 110 to the server 120. For example, the network 115 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 115 may include, without limitation, telephone lines, fiber optics, IEEE Ethernet 902.3, a wide area network, a wireless personal area network, a LAN, or a global network such as the Internet. In addition, the network 115 may support an Internet network, a wireless communication network, a cellular network, or the like, or any combination thereof. The network 115 may further include one network, or any number of the exemplary types of networks mentioned above, operating as a stand-alone network or in cooperation with each other. The network 115 may utilize one or more protocols of one or more network elements to which they are communicatively coupled. The network 115 may translate to or from other protocols to one or more protocols of network devices. Although the network 115 is depicted as a single network, it should be appreciated that according to one or more examples, the network 115 may comprise a plurality of interconnected networks, such as, for example, the Internet, a service provider's network, a cable television network, corporate networks, such as credit card association networks, and home networks. In the present disclosure, a network (such as NFC) through which the communication between the contactless card 105 and the client device 110 is performed, may be referred to as a first network, and the network 115 may be referred to as a second network.

The system 100 may include one or more servers 120. In some examples, the server 120 may include one or more processors, which are coupled to the memory of the server 120. The server 120 may be configured as a central system, server or platform to control and call various data at different times to execute a plurality of workflow actions. The server 120 may be configured to connect to the one or more databases. The server 120 may be connected to at least one client device 110.

In some examples, exemplary procedures in accordance with the present disclosure described herein can be performed by a computer hardware arrangement. Such a computer hardware arrangement can be, for example entirely or a part of, or include, but not limited to, a computer and/or processor that can include, for example one or more microprocessors, and use instructions stored on a non-transitory computer-accessible medium (e.g., RAM, ROM, hard drive, or other storage device). For example, a computer-accessible medium can be part of the memory of the contactless card 105, the client device 110, and/or the server 120, or other computing and/or processing arrangement.

In some examples, a computer-accessible medium (e.g., as described herein, a storage device such as a hard disk, floppy disk, memory stick, CD-ROM, RAM, ROM, etc., or a combination thereof) can be provided (e.g., in communication with the computer hardware arrangement). The computer-accessible medium can contain executable instructions thereon. In addition or alternatively, a storage arrangement can be provided separately from the computer-accessible medium, which can provide the instructions to the computer hardware arrangement. The instructions can configure the computer hardware arrangement to execute certain exemplary procedures, processes, and methods, as described herein above, for example.

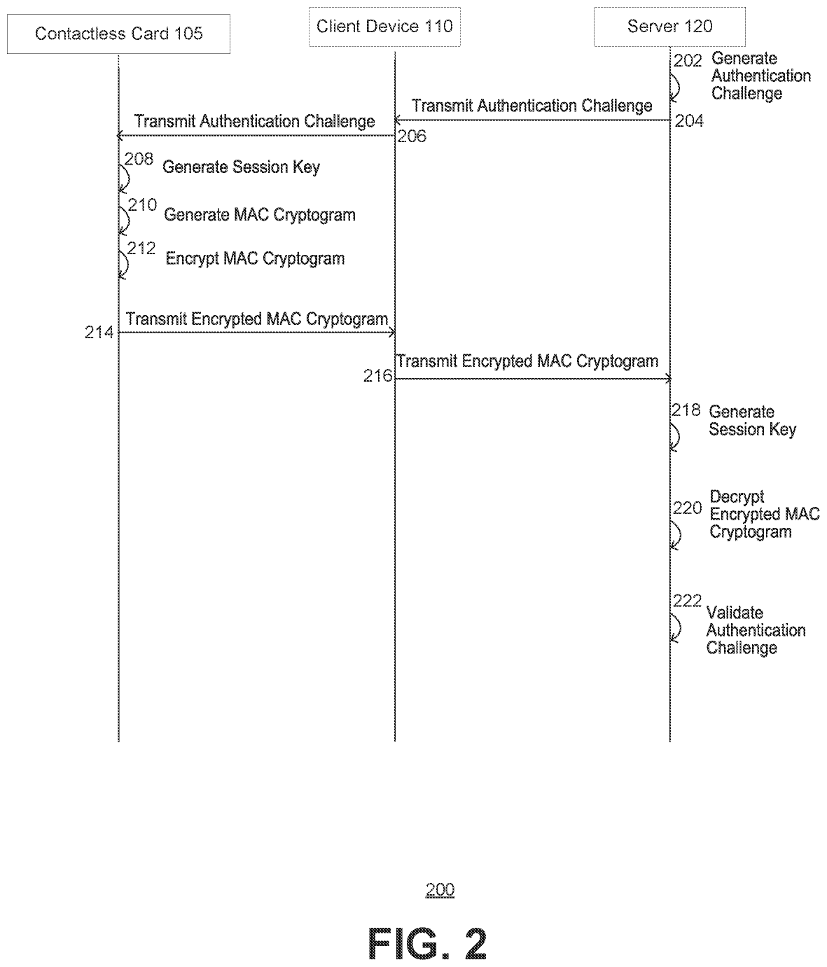

FIG. 2 is a timing diagram illustrating an example sequence 200 for providing authenticated access according to one or more embodiments of the present disclosure. The example sequence 200 may be implemented in the system 100. FIG. 2 may reference similar components as illustrated in FIG. 1, such as a contactless card 105 (a first device), a client device 110 (a second device), and a server 120. It should be noted that the following steps in the example sequence 200 may be performed in different order, one or more of the following steps may be omitted, and/or one or more additional steps may be added to the example sequence.

At step 202, the server 120 may generate an authentication challenge, such as a random numerical value/number, a random text, or a combination of thereof. The authentication challenge may be generated by the processor of the server 120 through an application deployed on the server 120. The server 120 may then store the authentication challenge in the memory of the server 120 and/or a database.

At step 204, the server 120 transmits the authentication challenge to the client device 110. The server 120 may then store the authentication challenge in the memory of the client device 110.

At step 206, the client device 110 transmits the authentication challenge to the contactless card 105. An application deployed on the client device 110 communicates with the contactless card 105 (e.g., after being brought near the contactless card 105) for data transmission between the client device 110 and the contactless card 105. Communication between the application of the client device 110 and the contactless card 105 may involve the contactless card 105 being sufficiently close to a card reader (not shown) of the client device 110 to enable NFC data transfer between the application of the client device 110 and the contactless card 105.

At step 208, the contactless card 105 may generate a session key using a master key and one or more cryptographic algorithms. The master key and the one or more cryptographic algorithms may be stored in the memory of the contactless card 105. The contactless card 105 may then store the session key in the memory of the contactless card 105.

At step 210, after the communication has been established between the client device 110 and the contactless card 105, the contactless card 105 generates a message authentication code (MAC) cryptogram. In some examples, this may occur when the contactless card 105 is read by the application of the client device 110. In particular, this may occur upon a read, such as an NFC read, of a near field data exchange (NDEF) tag, which may be created in accordance with the NFC Data Exchange Format. For example, a reader, such as the application of the client device 110, may transmit a message, such as an applet select message, with the applet ID of an NDEF producing applet. Upon confirmation of the selection, a sequence of select file messages followed by read file messages may be transmitted. For example, the sequence may include “Select Capabilities file”, “Read Capabilities file”, and “Select NDEF file”. At this point, a counter value maintained by the contactless card 105 (e.g., stored in the memory of the contactless card 105) may be updated or incremented, which may be followed by “Read NDEF file.” At this point, the MAC message may be generated which may include a header, the authentication challenge, and/or a shared secret. Session keys may then be generated. The MAC cryptogram may be created from the MAC message over the counter value and the authentication challenge using the one or more cryptographic algorithms and the session key, which may include the header, the authentication challenge, and/or the shared secret.

At step 212, the MAC cryptogram may then be concatenated with one or more blocks of random data, and the MAC cryptogram and a random number (RND) may be encrypted with the session key and/or the one or more cryptographic algorithms. Thereafter, the cryptogram and the header may be concatenated, and encoded as ASCII hex and returned in NDEF message format (responsive to the “Read NDEF file” message).

In some examples, the MAC cryptogram may be transmitted as an NDEF tag, and in other examples the MAC cryptogram may be included with a uniform resource indicator (e.g., as a formatted string).

In some examples, the application of the client device 110 may be configured to transmit a request to the contactless card 105, the request comprising an instruction to generate a MAC cryptogram.

At step 214, the contactless card 105 sends the encrypted MAC cryptogram to the application of the client device 110. In some examples, the transmission of the encrypted MAC cryptogram occurs via NFC, however, the present disclosure is not limited thereto. In other examples, this communication may occur via Bluetooth, Wi-Fi, or other means of wireless data communication.

At step 216, the application of the client device 110 communicates the encrypted MAC cryptogram to the server 120, through a network such as the network 115.

At step 218, the server 120 may generate the session key based on the master key, and store the session key in the memory of the server 120 or a database. The master key is also stored in the memory of the server 120 or the database.

At step 220, the server 120 may decrypt the encrypted MAC cryptogram using the one or more cryptographic algorithms and the session key. For example, the server 120 may extract from the encrypted MAC cryptogram the counter value and the authentication challenge.

At step 222, the server 120 may verify the MAC cryptogram to validate the authentication challenge. For example, a MAC may be reconstructed by the server 120 using the session key and the authentication challenge, and then the reconstructed MAC is compared with the decrypted MAC to determine if they are the same. If they are the same, then the decrypted MAC can be verified and the authentication challenge is validated. In another example, the server 120 may compare the authentication challenge extracted from the MAC cryptogram with the authentication challenge generated by the server 120 and stored in the memory of the server 120. If the two authentication challenges match each other, the MAC cryptogram can be verified and the authentication challenge can be validated. Therefore, the contactless card 105 can be authenticated. The server 120 may also increase the counter value and store the updated counter value in the memory of the server 120 and/or the database. The server may

In some examples, verifying the MAC cryptogram may be performed by the client device 110. In some examples, the MAC cryptogram may function as a digital signature for purposes of verification. Other digital signature algorithms, such as public key asymmetric algorithms, e.g., the Digital Signature Algorithm and the RSA algorithm, or zero knowledge protocols, may be used to perform this verification.

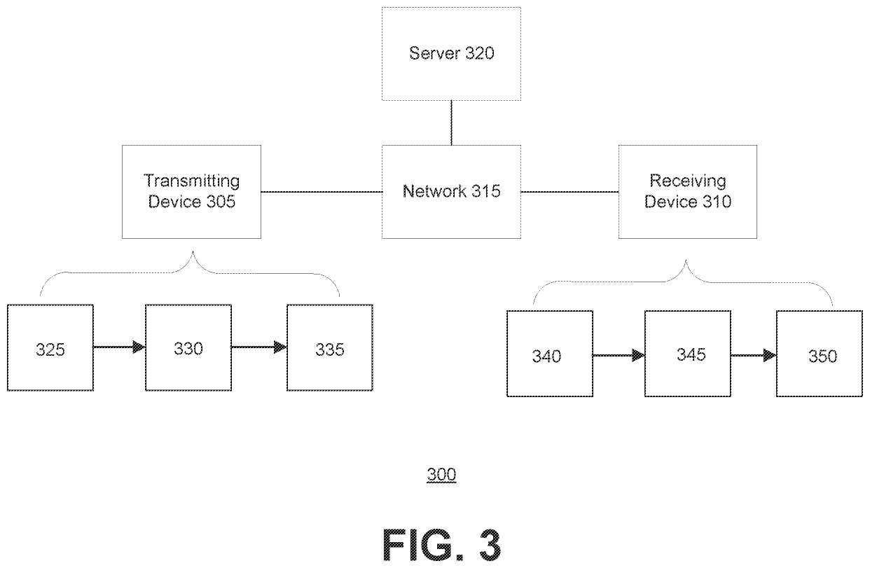

FIG. 3 illustrates a data transmission system according to an example embodiment. The system 300 may include a transmitting or sending device 305 (e.g., a contactless card), a receiving or recipient device 310 (e.g., a client device) in communication, for example via a network 315, with one or more servers 320. The transmitting or sending device 305 may be the same as, or similar to, the contactless card 105 discussed above with reference to FIG. 1. The receiving or recipient device 310 may be the same as, or similar to, the client device 110 discussed above with reference to FIG. 1. The network 315 may be similar to the network 115 discussed above with reference to FIG. 1. The server 320 may be similar to the server 120 discussed above with reference to FIG. 1. Although FIG. 3 shows single instances of components of the system 300, the system 300 may include any number of the illustrated components. In the system 300, a MAC cryptogram may be verified by a client device (the receiving device 310) instead of a server as in FIG. 1, and an authentication challenge may also be validated by the client device.

When using symmetric cryptographic algorithms, such as encryption algorithms, hash-based message authentication code (HMAC) algorithms, and cipher-based message authentication code (CMAC) algorithms, it is important that the key remain secret between the party that originally processes the data that is protected using a symmetric algorithm and the key, and the party who receives and processes the data using the same cryptographic algorithm and the same key.

It is also important that the same key is not used too many times. If a key is used or reused too frequently, that key may be compromised. Each time the key is used, it provides an attacker an additional sample of data which was processed by the cryptographic algorithm using the same key. The more data which the attacker has which was processed with the same key, the greater the likelihood that the attacker may discover the value of the key. A key used frequently may be comprised in a variety of different attacks.

Moreover, each time a symmetric cryptographic algorithm is executed, it may reveal information, such as side-channel data, about the key used during the symmetric cryptographic operation. Side-channel data may include minute power fluctuations which occur as the cryptographic algorithm executes while using the key. Sufficient measurements may be taken of the side-channel data to reveal enough information about the key to allow it to be recovered by the attacker. Using the same key for exchanging data would repeatedly reveal data processed by the same key.

However, by limiting the number of times a particular key will be used, the amount of side-channel data which the attacker is able to gather is limited and thereby reduce exposure to this and other types of attack. As further described herein, the parties involved in the exchange of cryptographic information (e.g., sender and recipient) can independently generate keys from an initial shared master symmetric key in combination with a counter value, and thereby periodically replace the shared symmetric key being used with needing to resort to any form of key exchange to keep the parties in sync. By periodically changing the shared secret symmetric key used by the sender and the recipient, the attacks described above are rendered impossible.

Referring back to FIG. 3, the system 300 may be configured to implement key diversification. For example, a sender and recipient may desire to exchange data (e.g., original sensitive data such as authenticating the transmitting device 305) via respective devices 305 and 310. As explained above, although single instances of transmitting device 305 and receiving device 310 may be included, it is understood that one or more transmitting devices 305 and one or more receiving devices 310 may be involved so long as each party shares the same shared secret symmetric key. In some examples, the transmitting device 305 and receiving device 310 may be provisioned with the same master symmetric key. Further, it is understood that any party or device holding the same secret symmetric key may perform the functions of the transmitting device 305 and similarly any party holding the same secret symmetric key may perform the functions of the receiving device 310. In some examples, the symmetric key may comprise the shared secret symmetric key which is kept secret from all parties other than the transmitting device 305 and the receiving device 310 involved in exchanging the secure data. It is further understood that both the transmitting device 305 and receiving device 310 may be provided with the same master symmetric key, and further that part of the data exchanged between the transmitting device 305 and receiving device 310 comprises at least a portion of data which may be referred to as the counter value. The counter value may comprise a number that changes each time data is exchanged between the transmitting device 305 and the receiving device 310.

The system 300 may include one or more networks 315. In some examples, the network 315 may be one or more of a wireless network, a wired network or any combination of wireless network and wired network, and may be configured to connect one or more transmitting devices 305 and one or more receiving devices 310 to the server 320. For example, the network 315 may include one or more of a fiber optics network, a passive optical network, a cable network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, RFID, Wi-Fi, and/or the like.

In addition, the network 315 may include, without limitation, telephone lines, fiber optics, IEEE Ethernet 902.3, a wide area network, a wireless personal area network, a LAN, or a global network such as the Internet. In addition, the network 315 may support an Internet network, a wireless communication network, a cellular network, or the like, or any combination thereof. The network 315 may further include one network, or any number of the exemplary types of networks mentioned above, operating as a stand-alone network or in cooperation with each other. The network 315 may utilize one or more protocols of one or more network elements to which they are communicatively coupled. The network 315 may translate to or from other protocols to one or more protocols of network devices. Although the network 315 is depicted as a single network, it should be appreciated that according to one or more examples, the network 315 may comprise a plurality of interconnected networks, such as, for example, the Internet, a service provider's network, a cable television network, corporate networks, such as credit card association networks, and home networks.

In some examples, one or more transmitting devices 305 and one or more receiving devices 310 may be configured to communicate and transmit and receive data between each other without passing through network 315. For example, communication between the one or more transmitting devices 305 and the one or more receiving devices 310 may occur via at least one of NFC, Bluetooth, RFID, Wi-Fi, and/or the like.

At block 325, when the transmitting device 305 is preparing to process the sensitive data with a symmetric cryptographic operation (for example, the transmitting device 305 being brought into the NFC field of the receiving device 310), the transmitting device 305 as the sender may update a counter. In addition, the transmitting device 305 may select an appropriate symmetric cryptographic algorithm, which may include at least one of a symmetric encryption algorithm, HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

At block 330, the transmitting device 305 may take the selected cryptographic algorithm, and using the master symmetric key, process the counter value. For example, the sender may select a symmetric encryption algorithm, and use a counter which updates with every conversation between the transmitting device 305 and the receiving device 310. The transmitting device 305 may then encrypt the counter value with the selected symmetric encryption algorithm using the master symmetric key, creating a diversified symmetric key.

In some examples, the counter value may not be encrypted. In these examples, the counter value may be transmitted between the transmitting device 305 and the receiving device 310 at block 330 without encryption.

At block 335, the diversified symmetric key may be used to process the sensitive data before transmitting the result to the receiving device 310. For example, the transmitting device 305 may encrypt the sensitive data using a symmetric encryption algorithm using the diversified symmetric key, with the output comprising the protected encrypted data (such as a MAC cryptogram or an encrypted MAC cryptogram). The sensitive data may include an authentication challenge. The authentication challenge may be generated by the receiving device 310 or the server 320 and then transmitted to the transmitting device 305. The transmitting device 305 may then transmit the protected encrypted data, along with the counter value, to the receiving device 310 for processing.

At block 340, the receiving device 310 may first take the counter value and then perform the same symmetric encryption using the counter value as input to the encryption, and the master symmetric key as the key for the encryption. The output of the encryption may be the same diversified symmetric key value that was created by the sender.

At block 345, the receiving device 310 may then take the protected encrypted data and using a symmetric decryption algorithm along with the diversified symmetric key, decrypt the protected encrypted data (the encrypted MAC cryptogram).

At block 350, as a result of the decrypting the protected encrypted data, the original sensitive data may be revealed. For example, the authentication challenge is verified and validated.

The next time sensitive data needs to be sent from the sender to the recipient via respective transmitting device 305 and receiving device 310, a different counter value may be selected producing a different diversified symmetric key, and a different authentication challenge may be used in the sensitive data. By processing the counter value with the master symmetric key and same symmetric cryptographic algorithm, both the transmitting device 305 and receiving device 310 may independently produce the same diversified symmetric key. This diversified symmetric key, not the master symmetric key, is used to protect the sensitive data.

As explained above, both the transmitting device 305 and receiving device 310 each initially possess the shared master symmetric key. The shared master symmetric key is not used to encrypt the original sensitive data. Because the diversified symmetric key is independently created by both the transmitting device 305 and receiving device 310, it is never transmitted between the two parties. Thus, an attacker cannot intercept the diversified symmetric key and the attacker never sees any data which was processed with the master symmetric key. Only the counter value is processed with the master symmetric key, not the sensitive data. As a result, reduced side-channel data about the master symmetric key is revealed. Moreover, the operation of the transmitting device 305 and the receiving device 310 may be governed by symmetric requirements for how often to create a new diversification value, and therefore a new diversified symmetric key. In an embodiment, a new diversification value and therefore a new diversified symmetric key may be created for every exchange between the transmitting device 305 and receiving device 310. Further, a different authentication challenge may be used in the sensitive data for every exchange between the transmitting device 305 and receiving device 310, thereby further improving data transmission security.

In some examples, the key diversification value may comprise the counter value. Other non-limiting examples of the key diversification value include: a random nonce generated each time a new diversified key is needed, the random nonce sent from the transmitting device 305 to the receiving device 310; the full value of a counter value sent from the transmitting device 305 to the receiving device 310; a portion of a counter value sent from the transmitting device 305 to the receiving device 310; a counter independently maintained by the transmitting device 305 and the receiving device 310 but not sent between the two devices; a one-time-passcode exchanged between the transmitting device 305 and the receiving device 310; and a cryptographic hash of the sensitive data. In some examples, one or more portions of the key diversification value may be used by the parties to create multiple diversified keys. For example, a counter may be used as the key diversification value. Further, a combination of one or more of the exemplary key diversification values described above may be used.

In another example, a portion of the counter may be used as the key diversification value. If multiple master key values are shared between the parties, the multiple diversified key values may be obtained by the systems and processes described herein. A new diversification value, and therefore a new diversified symmetric key, may be created as often as needed. In the most secure case, a new diversification value may be created for each exchange of sensitive data between the transmitting device 305 and the receiving device 310. In effect, this may create a one-time use key, such as a single-use session key.

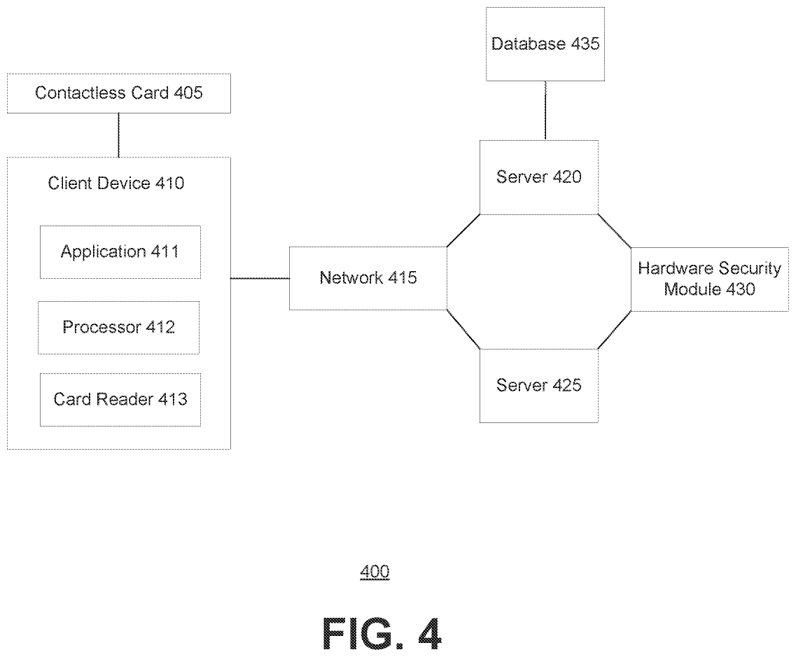

FIG. 4 illustrates a system 400 using a contactless card along with an authentication challenge. The system 400 may include a contactless card 405, one or more client devices 410, a network 415, servers 420, 425, one or more hardware security modules 430, and a database 435. Although FIG. 4 illustrates single instances of the components, the system 400 may include any number of components.

The system 400 may include one or more contactless cards 405, which are further explained below with respect to FIGS. 6A-6B. In some examples, the contactless card 405 may be in wireless communication, for example NFC communication, with the client device 410. For example, the contactless card 405 may comprise one or more chips, such as a radio frequency identification chip, configured to communication via NFC or other short-range protocols. In other embodiments, the contactless card 405 may communicate with the client device 410 through other means including, but not limited to, Bluetooth, satellite, Wi-Fi, wired communications, and/or any combination of wireless and wired connections. According to some embodiments, the contactless card 405 may be configured to communicate with a card reader 413 of client device 410 through NFC when the contactless card 405 is within a range of card reader 413. In other examples, communications with the contactless card 405 may be accomplished through a physical interface, e.g., a universal serial bus interface or a card swipe interface.

The system 400 may include the client device 410, which may be a network-enabled computer. As referred to herein, a network-enabled computer may include, but is not limited to: e.g., a computer device, or communications device including, e.g., a server, a network appliance, a personal computer, a workstation, a mobile device, a phone, a handheld PC, a personal digital assistant, a thin client, a fat client, an Internet browser, or other device. One or more client devices 410 also may be a mobile device; for example, a mobile device may include an iPhone, iPod, iPad from Apple® or any other mobile device running Apple's iOS® operating system, any device running Microsoft's Windows® Mobile operating system, any device running Google's Android® operating system, and/or any other smartphone or like wearable mobile device. In some examples, the client device 410 may be the same as, or similar to, a client device 110 as described with reference to FIG. 1.

The client device 410 may be in communication with the one or more servers 420 and 425 via the one or more networks 415. The client device 410 may transmit, for example from an application 411 executing on the client device 410, one or more requests to the one or more servers 420 and 425. The one or more requests may be associated with retrieving data from the one or more servers 420 and 425. The servers 420 and 425 may receive the one or more requests from the client device 410. Based on the one or more requests from the client device 410, the one or more servers 420 and 425 may be configured to retrieve the requested data from the one or more databases 435 and/or generate an authentication challenge. Based on receipt of the requested data from the one or more databases 435, the one or more servers 420 and 425 may be configured to transmit the received data/the generated authentication challenge to the client device 410, the received data/the generated authentication challenge being responsive to the one or more requests.

The system 400 may include one or more hardware security modules (HSM) 430. For example, the one or more HSMs 430 may be configured to perform one or more cryptographic operations as disclosed herein. In some examples, the one or more HSMs 430 may be configured as special purpose security devices that are configured to perform the one or more cryptographic operations. The HSMs 430 may be configured such that keys are never revealed outside the HSM 430, and instead are maintained within the HSM 430. For example, the one or more HSMs 430 may be configured to perform at least one of key derivations, decryption, and MAC operations. The one or more HSMs 430 may be contained within, or may be in data communication with, the servers 420 and 425.

The system 400 may include one or more networks 415. In some examples, the network 415 may be one or more of a wireless network, a wired network or any combination of wireless network and wired network, and may be configured to connect the client device 410 to the server 420 and 425. For example, the network 415 may include one or more of a fiber optics network, a passive optical network, a cable network, a cellular network, an Internet network, a satellite network, a wireless LAN, a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, RFID, Wi-Fi, and/or any combination of networks thereof. As a non-limiting example, communications between the contactless card 405 and client device 410 may comprise NFC communication, cellular network between the client device 410 and a carrier, and Internet between the carrier and a back-end.

In addition, the network 415 may include, without limitation, telephone lines, fiber optics, IEEE Ethernet 902.3, a wide area network, a wireless personal area network, a local area network, or a global network such as the Internet. In addition, network 415 may support an Internet network, a wireless communication network, a cellular network, or the like, or any combination thereof. The network 415 may further include one network, or any number of the exemplary types of networks mentioned above, operating as a stand-alone network or in cooperation with each other. The network 415 may utilize one or more protocols of one or more network elements to which they are communicatively coupled. The network 415 may translate to or from other protocols to one or more protocols of network devices. Although the network 415 is depicted as a single network, it should be appreciated that according to one or more examples, the network 415 may comprise a plurality of interconnected networks, such as, for example, the Internet, a service provider's network, a cable television network, corporate networks, such as credit card association networks, and home networks.

In various examples according to the present disclosure, the client device 410 of the system 400 may execute one or more applications 411, and include one or more processors 412, and one or more card readers 413. For example, the one or more applications 411, such as software applications, may be configured to enable, for example, network communications with one or more components of the system 400 and transmit and/or receive data. It is understood that although only single instances of the components of client device 410 are illustrated in FIG. 4, any number of the client devices 410 may be used. The card reader 413 may be configured to read from and/or communicate with the contactless card 405. In conjunction with the one or more applications 411, the card reader 413 may communicate with the contactless card 405.

The application 411 of the client device 410 may communicate with the contactless card 405 using short-range wireless communication (e.g., NFC). The application 411 may be configured to interface with the card reader 413 of the client device 410 configured to communicate with the contactless card 405. As should be noted, those skilled in the art would understand that a distance of less than twenty centimeters is consistent with NFC range.

In some embodiments, the application 411 communicates through an associated reader (e.g., card reader 413) with the contactless card 405.

In some embodiments, the contactless card 405 may communicate with the application 411 through the card reader 413 of the client device 410 through NFC. The communication (e.g., a tap of the contactless card 405 proximate the card reader 413 of the client device 410) allows the application 411 to read the data associated with the contactless card 405 and perform an authentication of the contactless card 405 based on an authentication challenge. In some cases, the tap may activate or launch the application 411 and then initiate one or more actions or communications with the one or more servers 420 and/or 425 to authenticate the contactless card 405 for subsequent use. In some cases, if the application 411 is not installed on the client device 410, a tap of the contactless card 405 against the card reader 413 may initiate a download of the application 411 (e.g., navigation to an application download page). Subsequent to installation, a tap of the contactless card 405 may activate or launch the application 411, and then initiate (e.g., via the application 411 or other back-end communication) authentication of the contactless card 405 based on an authentication challenge.

According to some embodiments, the contactless card 405 may include a virtual payment card. In those embodiments, the application 411 may retrieve information associated with the contactless card 405 by accessing a digital wallet implemented on the client device 410, wherein the digital wallet includes the virtual payment card. In some examples, virtual payment card data may include one or more static or dynamically generated virtual card numbers.

The server 420 may comprise a web server in communication with the database 435. The server 425 may comprise an account server. In some examples, the server 420 may be configured to validate one or more credentials from the contactless card 405 and/or client device 410 by comparison with one or more credentials in database 445. The server 425 may be configured to authorize one or more requests, such as payment and transaction, from the contactless card 405 and/or client device 410.

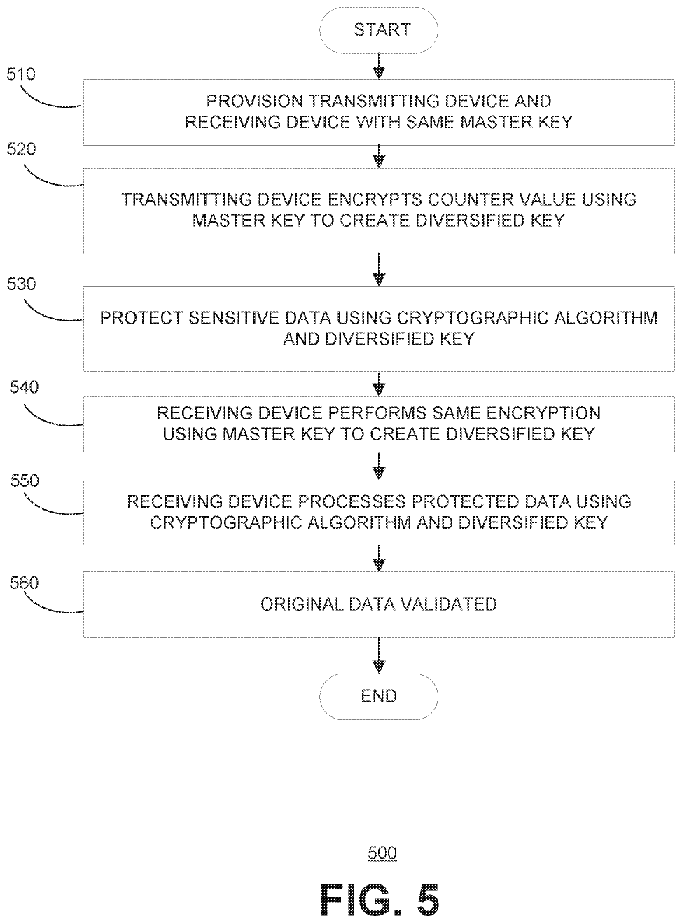

FIG. 5 illustrates a method 500 of key diversification according to an example of the present disclosure. The method 500 may include a transmitting device and receiving device similar to the transmitting device 305 (such as a contactless card) and receiving device 310 (such as a client device) referenced in FIG. 3.

For example, a sender and a recipient may desire to exchange data (e.g., original sensitive data including an authentication challenge) via a transmitting device and a receiving device, respectively. As explained above, although these two parties may be included, it is understood that one or more transmitting devices and one or more receiving devices may be involved so long as each party shares the same shared secret symmetric key. In some examples, the transmitting device and receiving device may be provisioned with the same master symmetric key. Further, it is understood that any party or device holding the same secret symmetric key may perform the functions of the transmitting device and similarly any party holding the same secret symmetric key may perform the functions of the receiving device. In some examples, the symmetric key may comprise the shared secret symmetric key which is kept secret from all parties other than the transmitting device and the receiving device involved in exchanging the secure data. It is further understood that both the transmitting device and receiving device may be provided with the same master symmetric key, and further that part of the data exchanged between the transmitting device and receiving device comprises at least a portion of data which may be referred to as the counter value. The counter value may comprise a number that changes each time data is exchanged between the transmitting device and the receiving device.

At block 510, a transmitting device and a receiving device may be provisioned with the same master key, such as the same master symmetric key. When the transmitting device is preparing to process the sensitive data with symmetric cryptographic operations, the sender may update a counter. In addition, the transmitting device may select an appropriate symmetric cryptographic algorithm, which may include at least one of a symmetric encryption algorithm, a HMAC algorithm, and a CMAC algorithm. In some examples, the symmetric algorithm used to process the diversification value may comprise any symmetric cryptographic algorithm used as needed to generate the desired length diversified symmetric key. Non-limiting examples of the symmetric algorithm may include a symmetric encryption algorithm such as 3DES or AES128; a symmetric HMAC algorithm, such as HMAC-SHA-256; and a symmetric CMAC algorithm, such as AES-CMAC. It is understood that if the output of the selected symmetric algorithm does not generate a sufficiently long key, techniques such as processing multiple iterations of the symmetric algorithm with different input data and the same master key may produce multiple outputs which may be combined as needed to produce sufficient length keys.

The transmitting device may take the selected cryptographic algorithm, and using the master symmetric key, process the counter value. For example, the sender may select a symmetric encryption algorithm, and use a counter which updates with every conversation between the transmitting device and the receiving device.

At block 520, the transmitting device may then encrypt the counter value with the selected symmetric encryption algorithm using the master symmetric key, creating a diversified symmetric key. The diversified symmetric key may be used to process the sensitive data before transmitting the result to the receiving device. For example, the transmitting device may encrypt the sensitive data using a symmetric encryption algorithm using the diversified symmetric key, with the output comprising the protected encrypted data. The transmitting device may then transmit the protected encrypted data, along with the counter value, to the receiving device for processing. In some examples, a cryptographic operation other than encryption may be performed, and a plurality of cryptographic operations may be performed using the diversified symmetric keys prior to transmittal of the protected data.

In some examples, the counter value may not be encrypted. In these examples, the counter value may be transmitted between the transmitting device and the receiving device at block 520 without encryption.

At block 530, the sensitive data may be protected using one or more cryptographic algorithms and the diversified keys. The diversified session keys, which may be created by the key diversification which uses the counter, may be used with one or more cryptographic algorithms to protect the sensitive data. For example, the sensitive data may be processed by a MAC using a first diversified session key, and the resulting output may be encrypted using the second diversified session key producing the protected data.

At block 540, the receiving device may perform the same symmetric encryptions using the counter value as input to the encryptions and the master symmetric keys as the keys for the encryption. The output of the encryptions may be the same diversified symmetric key values that were created by the sender. For example, the receiving device may independently create its own copies of the first and second diversified session keys using the counter. Then, the receiving device may decrypt the protected data using the second diversified session key to reveal the output of the MAC created by the transmitting device. The receiving device may then process the resultant data through the MAC operation using the first diversified session key.

At block 550, the receiving device may use the diversified session keys with one or more cryptographic algorithms to validate the protected data.

At block 460, the original data including the authentication challenge may be validated. If the output of the MAC operation (via the receiving device using the first diversified session key) matches the MAC output revealed by decryption, then the data may be deemed valid.

The next time sensitive data needs to be sent from the transmitting device to the receiving device, a different counter value may be selected, which produces a different diversified symmetric key, and a different authentication challenge may be generated by the receiving device and written into the transmitting device prior to transmission of sensitive data. By processing the counter value with the master symmetric key and same symmetric cryptographic algorithm, both the transmitting device and receiving device may independently produce the same diversified symmetric key. This diversified symmetric key, not the master symmetric key, is used to protect the sensitive data.

As explained above, both the transmitting device and receiving device each initially possess the shared master symmetric key. The shared master symmetric key is not used to encrypt the original sensitive data. Because the diversified symmetric key is independently created by both the transmitting device and receiving device, it is never transmitted between the two parties. Thus, an attacker cannot intercept the diversified symmetric key and the attacker never sees any data which was processed with the master symmetric key. Only the small counter value is processed with the master symmetric key, not the sensitive data. As a result, reduced side-channel data about the master symmetric key is revealed. Moreover, the sender and the recipient may agree, for example by prior arrangement or other means, how often to create a new diversification value, and therefore a new diversified symmetric key. In an embodiment, a new diversification value and therefore a new diversified symmetric key may be created for every exchange between the transmitting device and receiving device.

In some examples, the key diversification value may comprise the counter value. Other non-limiting examples of the key diversification value include: a random nonce generated each time a new diversified key is needed, the random nonce sent from the transmitting device to the receiving device; the full value of a counter value sent from the transmitting device and the receiving device; a portion of a counter value sent from the transmitting device and the receiving device; a counter independently maintained by the transmitting device and the receiving device but not sent between the two; a one-time-passcode exchanged between the transmitting device and the receiving device; cryptographic hash of the sensitive data. In some examples, one or more portions of the key diversification value may be used by the parties to create multiple diversified keys. For example, a counter may be used as the key diversification value.

In another example, a portion of the counter may be used as the key diversification value. If multiple master key values are shared between the parties, the multiple diversified key values may be obtained by the system and processes described herein. A new diversification value, and therefore a new diversified symmetric key, may be created as often as needed. In the most secure case, a new diversification value may be created for each exchange of sensitive data between the transmitting device and the receiving device. In effect, this may create a one-time use key, such as a single session key.

In other examples, such as to limit the number of times of use of the master symmetric key, it may be agreed upon by the sender of transmitting device and recipient of the receiving device that a new diversification value, and therefore a new diversified symmetric key, will happen only periodically. In one example, this may be after a predetermined number of uses, such as every 10 transmissions between the transmitting device and the receiving device. In another example, this may be after a certain time period, a certain time period after a transmission, or on a periodic basis (e.g., daily at a designated time; weekly at a designated time on a designated day). In another example, this may be every time the receiving device signals to the transmitting device that it desires to change the key on the next communication. This may be controlled on policy and may be varied due to, for example, the current risk level perceived by the recipient of the receiving device.

FIG. 6A illustrates one or more contactless cards 600, which may comprise a payment card, such as a credit card, debit card, or gift card, issued by a service provider 605 displayed on the front or back of the card 600. In some examples, the contactless card 600 is not related to a payment card, and may comprise, without limitation, an identification card. In some examples, the payment card may comprise a dual interface contactless payment card. The contactless card 600 may comprise a substrate 610, which may include a single layer or one or more laminated layers composed of plastics, metals, and other materials. Exemplary substrate materials include polyvinyl chloride, polyvinyl chloride acetate, acrylonitrile butadiene styrene, polycarbonate, polyesters, anodized titanium, palladium, gold, carbon, paper, and biodegradable materials. In some examples, the contactless card 600 may have physical characteristics compliant with the ID-1 format of the ISO/IEC 7810 standard, and the contactless card may otherwise be compliant with the ISO/IEC 14443 standard. However, it is understood that the contactless card 600 according to the present disclosure may have different characteristics, and the present disclosure does not require a contactless card to be implemented in a payment card.

The contactless card 600 may also include identification information 615 displayed on the front and/or back of the card, and a contact pad 620. The contact pad 620 may be configured to establish contact with another communication device, such as a user device, smart phone, laptop, desktop, or tablet computer. The contactless card 600 may also include processing circuitry, antenna and other components not shown in FIG. 6A. These components may be located behind the contact pad 620 or elsewhere on the substrate 610. The contactless card 600 may also include a magnetic strip or tape, which may be located on the back of the card (not shown in FIG. 6A).

As illustrated in FIG. 6B, the contact pad 620 of FIG. 6A may include processing circuitry 625 for storing and processing information, including a microprocessor 630 and a memory 635. It is understood that the processing circuitry 625 may contain additional components, including processors, memories, error and parity/CRC checkers, data encoders, anticollision algorithms, controllers, command decoders, security primitives and tamperproofing hardware, as necessary to perform the functions described herein.

The memory 635 may be a read-only memory, write-once read-multiple memory or read/write memory, e.g., RAM, ROM, and EEPROM, and the contactless card 600 may include one or more of these memories. A read-only memory may be factory programmable as read-only or one-time programmable. One-time programmability provides the opportunity to write once then read many times. A write once/read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

The memory 635 may be configured to store one or more applets 640, one or more counters 645, and a customer identifier 650. The one or more applets 640 may comprise one or more software applications configured to execute on one or more contactless cards, such as Java Card applet. However, it is understood that applets 640 are not limited to Java Card applets, and instead may be any software application operable on contactless cards or other devices having limited memory. The one or more counters 645 may comprise a numeric counter sufficient to store an integer. The customer identifier 650 may comprise a unique alphanumeric identifier assigned to a user of the contactless card 600, and the identifier may distinguish the user of the contactless card from other contactless card users. In some examples, the customer identifier 650 may identify both a customer and an account assigned to that customer and may further identify the contactless card associated with the customer's account.

The processor and memory elements of the foregoing exemplary embodiments are described with reference to the contact pad, but the present disclosure is not limited thereto. It is understood that these elements may be implemented outside of the pad 620 or entirely separate from it, or as further elements in addition to processor 630 and memory 635 elements located within the contact pad 620.

In some examples, the contactless card 600 may comprise one or more antennas 655. The one or more antennas 655 may be placed within the contactless card 600 and around the processing circuitry 625 of the contact pad 620. For example, the one or more antennas 655 may be integral with the processing circuitry 625 and the one or more antennas 655 may be used with an external booster coil. As another example, the one or more antennas 655 may be external to the contact pad 620 and the processing circuitry 625.

In an embodiment, the coil of contactless card 600 may act as the secondary of an air core transformer. The terminal may communicate with the contactless card 600 by cutting power or amplitude modulation. The contactless card 600 may infer the data transmitted from the terminal using the gaps in the contactless card's power connection, which may be functionally maintained through one or more capacitors. The contactless card 600 may communicate back by switching a load on the contactless card's coil or load modulation. Load modulation may be detected in the terminal's coil through interference.

As explained above, the contactless cards 600 may be built on a software platform operable on smart cards or other devices having limited memory, such as JavaCard, and one or more applications or applets may be securely executed. Applets may be added to contactless cards to provide a one-time password (OTP) for multifactor authentication (MFA) in various mobile application-based use cases. Applets may be configured to respond to one or more requests, such as near field data exchange requests, from a reader, such as a mobile NFC reader, and produce an NDEF message that comprises a cryptographically secure OTP encoded as an NDEF text tag.

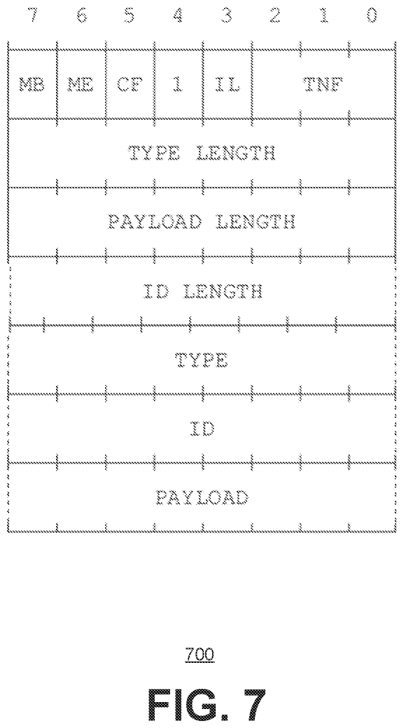

FIG. 7 illustrates NDEF short-record layout (SR=1) 700 according to an example embodiment. One or more applets may be configured to encode the OTP as an NDEF type 4 well known type text tag. In some examples, NDEF messages may comprise one or more records. The applets may be configured to add one or more static tag records in addition to the OTP record. Exemplary tags include, without limitation, Tag type: well known type, text, encoding English (en); Applet ID: D2760000850101; Capabilities: read-only access or read-write access; Encoding: the authentication message may be encoded as ASCII hex; type-length-value (TLV) data may be provided as a personalization parameter that may be used to generate the NDEF message. In an embodiment, the authentication template may comprise the first record, with a well-known index for providing the actual dynamic authentication data.

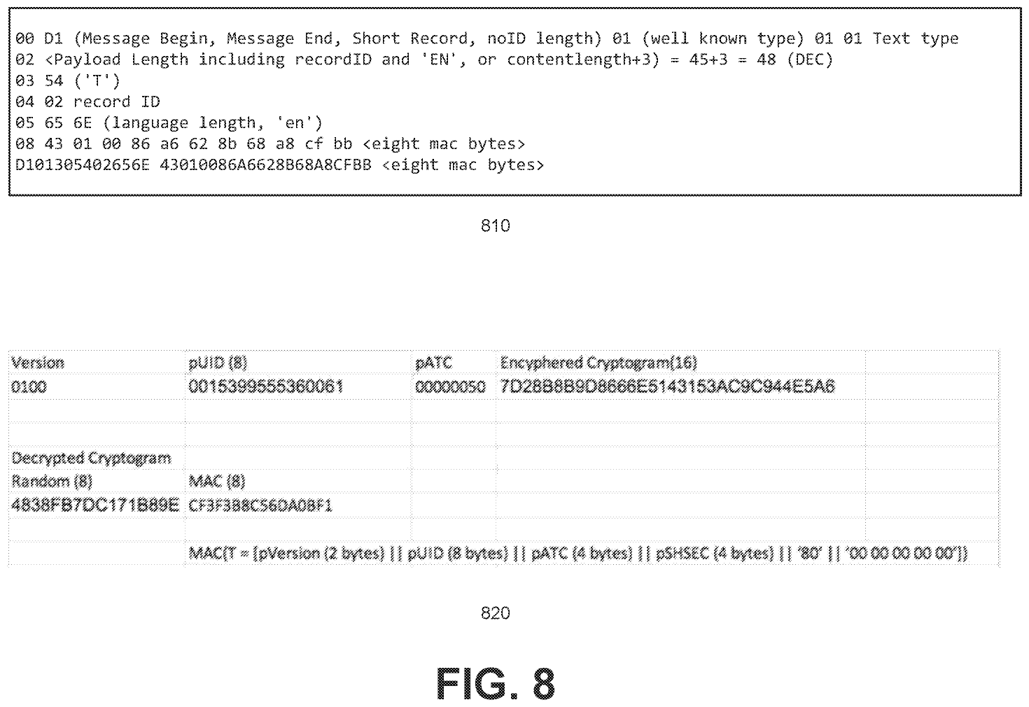

FIG. 8 illustrates a message 810 and a message format 820 according to an example embodiment. In one example, if additional tags are to be added, the first byte may change to indicate message begin, but not end, and a subsequent record may be added. Because ID length is zero, ID length field and ID are omitted from the record. An example message may include: UDK AUT key; Derived AUT session key (using 0×00000050); Version 1.0; pATC=0×00000050; RND=4838FB7DC171B89E; MAC=<eight computed bytes>.

In some examples, data may be stored in the contactless card at personalization time by implementing STORE DATA (E2) under secure channel protocol 2. One or more values may be read by the personalization bureau from the EMBOSS files (in a section designated by the Applet ID) and one or more store data commands may be transmitted to the contactless card after authentication and secure channel establishment.

pUID may comprise a 16-digit BCD encoded number. In some examples, pUID may comprise 14 digits.

| | Length | | | |
|---|---|---|---|---|
| Item | (bytes) | | Encrypted? | Notes |
| pUID | 8 | | No | |
| AutKey | 16 | | Yes | 3DES Key for Deriving MAC |
| | | | | session keys |
| AutKCV | 3 | | No | Key Check Value |
| DEKKey | 16 | | Yes | 3DES Key for deriving |
| | | | | Encryption session key |
| DEKKCV | 3 | | No | Key Check Value |
| Card Shared | 4 | bytes | No | 4 Byte True Random number |
| Random | | | | (pre-generated) |
| NTLV | X | Bytes | No | TLV data for NDEF message |

In some examples, the one or more applets may be configured to maintain its personalization state to allow personalization only if unlocked and authenticated. Other states may comprise standard states pre-personalization. On entering into a terminated state, the one or more applets may be configured to remove personalization data. In the terminated state, the one or more applets may be configured to stop responding to all application protocol data unit (APDU) requests.

The one or more applets may be configured to maintain an applet version (2 bytes), which may be used in the authentication message. In some examples, this may be interpreted as most significant byte major version, least significant byte minor version. The rules for each of the versions are configured to interpret the authentication message: For example, regarding the major version, this may include that each major version comprises a specific authentication message layout and specific algorithms. For the minor version, this may include no changes to the authentication message or cryptographic algorithms, and changes to static tag content, in addition to bug fixes, security hardening, etc.

In some examples, the one or more applets may be configured to emulate an RFID tag. The RFID tag may include one or more polymorphic tags. In some examples, each time the tag is read, different cryptographic data is presented that may indicate the authenticity of the contactless card. Based on the one or more applications, an NFC read of the tag may be processed, the token may be transmitted to a server, such as a backend server, and the token may be validated at the server.

In some examples, the contactless card and server may include certain data (e.g., an authentication challenge) such that the card may be properly identified. The contactless card may comprise one or more unique identifiers. Each time a read operation takes place, a counter may be configured to update. Each time a read operation takes place, an authentication challenge may be updated. In some examples, each time the card is read, it is transmitted to the server for validation and determines whether the counter is equal (as part of the validation). In some examples, each time the card is read, it is transmitted to the server for validation and determines whether the authentication challenge matches (as part of the validation/authentication).

The one or more counters may be configured to prevent a replay attack. For example, if a cryptogram has been obtained and replayed, that cryptogram is immediately rejected if the counter has been read or used or otherwise passed over. If the counter has not been used, it may be replayed, in such case, an authentication challenge can be used to prevent from replaying attack. In some examples, the counter that is updated on the card is different from the counter that is updated for transactions. In some examples, the contactless card may comprise a first applet, which may be a transaction applet, and a second applet. Each applet may comprise a counter.

In some examples, the counter may get out of sync between the contactless card and one or more servers. For example, the contactless card may be activated causing the counter to be updated and a new communication to be generated by the contactless card, but the communication may be not be transmitted for processing at the one or more servers. This may cause the counter of the contactless card and the counter maintained at the one or more servers to get out of sync. This may occur unintentionally including, for example, where a card is stored adjacent to a device (e.g., carried in a pocket with a device) and where the contactless card is read at an angle may include the card being misaligned or not positioned such that the contactless card is powered up an the NFC field but is not readable. If the contactless card is positioned adjacent to a device, the device's NFC field may be turned on to power the contactless card causing the counter therein to be updated, but no application on the device receives the communication.

To keep the counter in sync, an application, such as a background application, may be executed that would be configured to detect when the mobile device wakes up and synchronize with the one or more servers indicating that a read that occurred due to detection to then move the counter forward. Since the counters of the contactless card and the one or more servers may get out of sync, the one or more servers may be configured to allow the counter of the contactless card to be updated a threshold or predetermined number of times before it is read by the one or more servers and still be considered valid. For example, if the counter is configured to increment (or decrement) by one for each occurrence indicating activation of the contactless card, the one or more servers may allow any counter value it reads from the contactless card as valid, or any counter value within a threshold range (e.g., from 1 to 10). Moreover, the one or more servers may be configured to request a gesture associated with the contactless card, such as a user tap, if it reads a counter value which has advanced beyond 10, but below another threshold range value (such as 1000). From the user tap, if the counter value is within a desired or acceptance range, authentication succeeds.

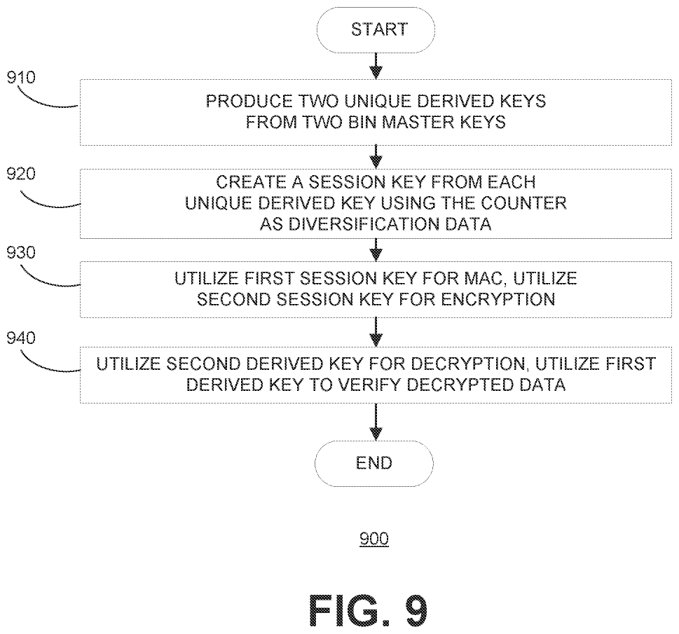

FIG. 9 is a flowchart illustrating key operations 900 according to an example embodiment. As illustrated in FIG. 9, at block 910, two bank identifier number (BIN) level master keys may be used in conjunction with the account identifier and card sequence number to produce two unique derived keys (UDKs) per card. In some examples, a bank identifier number may comprise one number or a combination of one or more numbers, such as an account number or an unpredictable number provided by one or more servers, may be used for session key generation and/or diversification. The UDKs (AUTKEY and ENCKEY) may be stored on the card during the personalization process.

At block 920, the counter may be used as the diversification data, since it changes with each use and provides a different session key each time, as opposed to the master key derivation in which one unique set of keys per card is produced. In some examples, it is preferable to use the 4-byte method for both operations. Accordingly, at block 920, two session keys may be created for each transaction from the UDKs, i.e., one session key from AUTKEY and one session key from ENCKEY. In the card, for the MAC key (i.e., the session key created from AUTKEY), the low order of two bytes of the OTP counter may be used for diversification. For the ENC key (i.e., the session key created from ENCKEY), the full length of the OTP counter may be used for the ENC key.

At block 930, the MAC key may be used for preparing the MAC cryptogram, and the ENC key may be used to encrypt the cryptogram. For example, the MAC session key may be used to prepare the cryptogram, and the result may be encrypted with the ENC key before it is transmitted to the one or more servers.

At block 940, verification and processing of the MAC is simplified because 2-byte diversification is directly supported in the MAC authentication functions of payment HSMs. Decryption of the cryptogram is performed prior to verification of the MAC. The session keys are independently derived at the one or more servers, resulting in a first session key (the ENC session key) and a second session key (the MAC session key). The second derived key (i.e., the ENC session key) may be used to decrypt the data, and the first derived key (i.e., the MAC session key) may be used to verify the decrypted data.

For the contactless card, a different unique identifier is derived which may be related to the application primary account number (PAN) and PAN sequence number, which is encoded in the card. The key diversification may be configured to receive the identifier as input with the master key such that one or more keys may be created for each contactless card. In some examples, these diversified keys may comprise a first key and a second key. The first key may include an authentication master key (Card Cryptogram Generation/Authentication Key-Card-Key-Auth), and may be further diversified to create a MAC session key used when generating and verifying a MAC cryptogram. The second key may comprise an encryption master key (Card Data Encryption Key-Card-Key-DEK), and may be further diversified to create an ENC session key used when encrypting and decrypting enciphered data. In some examples, the first and the second keys may be created by diversifying the issuer master keys by combining them with the card's unique ID number (pUID) and the PAN sequence number (PSN) of a payment applet. The pUID may comprise a 16-digit numerical value. As explained above, pUID may comprise a 16 digit BCD encoded number. In some examples, pUID may comprise a 14-digit numerical value.

In some examples, since the EMV session key derivation method may wrap at 2\hat{ }16 uses, the counter such as the full 32-bit counter may be added to the initialization arrays of the diversification method.

In other examples, such as credit cards, a number, such as an account number or an unpredictable number provided by one or more servers, may be used for session key generation and/or diversification.

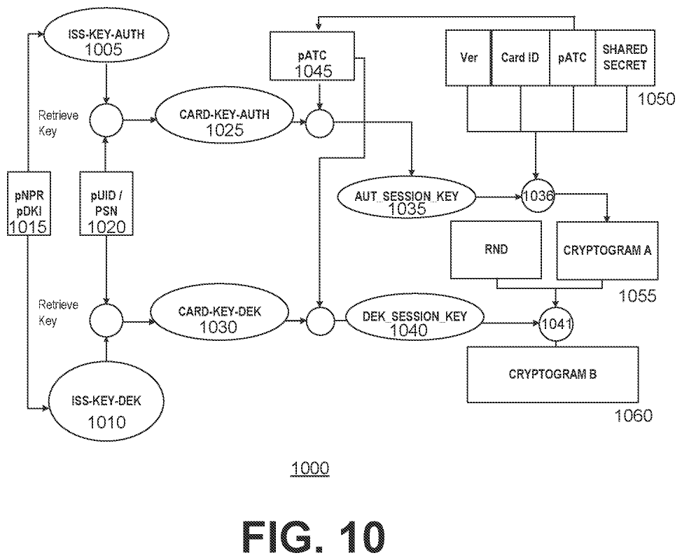

FIG. 10 illustrates a diagram of a system 1000 configured to implement one or more embodiments of the present disclosure. As explained below, during the contactless card creation process, two cryptographic keys may be assigned uniquely for each card. The cryptographic keys may comprise symmetric keys which may be used in both encryption and decryption of data. Triple DES (3DES) algorithm may be used by EMV and it is implemented by hardware in the contactless card. By using a key diversification process, one or more keys may be derived from a master key based upon uniquely identifiable information for each entity that requires a key.

Regarding master key management, two issuer master keys 1005, 1010 may be required for each part of the portfolio on which the one or more applets is issued. For example, the first master key 1005 may comprise an Issuer Cryptogram Generation/Authentication Key (Iss-Key-Auth) and the second master key 1010 may comprise an Issuer Data Encryption Key (Iss-Key-DEK). As further explained herein, two issuer master keys 1005, 1010 are diversified into card master keys 1025, 1030, which are unique for each card. In some examples, a network profile record ID (pNPR) and derivation key index (pDKI) 1015 and/or the card's unique ID number (pUID) and the PAN sequence number (PSN) 1020, as back office data, may be used to identify which Issuer Master Keys 1005, 1010 to use in the cryptographic processes for authentication. The system performing the authentication may be configured to retrieve values of pNPR and pDKI 1015 for a contactless card at the time of authentication.

In some examples, to increase the security of the solution, a session key may be derived (such as a unique key per session) but rather than using the master key, the unique card-derived keys and the counter may be used as diversification data, as explained above. For example, each time the card is used in operation, a different key may be used for creating the message authentication code (MAC) and for performing the encryption. Regarding session key generation, the keys used to generate the cryptogram and encipher the data in the one or more applets may comprise session keys based on the card unique keys (Card-Key-Auth 1025 and Card-Key-Dek 1030). The session keys (Aut-Session-Key 1035 and DEK-Session-Key 1040) may be generated by the one or more applets and derived by using the application transaction counter (pATC) 1045 with one or more algorithms. To fit data into the one or more algorithms, only the 2 low order bytes of the 4-byte pATC 1045 is used. In some examples, the four byte session key derivation method may comprise: F1:=PATC(lower 2 bytes)∥‘F0’∥‘00’∥PATC (four bytes) F1:=PATC(lower 2 bytes)∥‘0F’∥‘00’∥ PATC (four bytes) SK:={(ALG(MK) [F1])∥ALG(MK) [F2]}, where ALG may include 3DES ECB and MK may include the card unique derived master key.

As described herein, one or more MAC session keys may be derived using the lower two bytes of pATC 1045 counter. At each tap of the contactless card, pATC 1045 is configured to be updated, and the card master keys Card-Key-AUTH 1025 and Card-Key-DEK 1030 are further diversified into the session keys Aut-Session-Key 1035 and DEK-Session-KEY 1040. The pATC 1045 may be initialized to zero at personalization or applet initialization time. In some examples, the pATC counter 1045 may be initialized at or before personalization, and may be configured to increment by one at each NDEF read.

Further, the update for each card may be unique, and assigned either by personalization, or algorithmically assigned by pUID or other identifying information. For example, odd numbered cards may increment or decrement by 2 and even numbered cards may increment or decrement by 5. In some examples, the update may also vary in sequential reads, such that one card may increment in sequence by 1, 3, 5, 2, 2, . . . repeating. The specific sequence or algorithmic sequence may be defined at personalization time, or from one or more processes derived from unique identifiers. This can make it harder for a replay attacker to generalize from a small number of card instances.

The authentication message may be delivered as the content of a text NDEF record in hexadecimal ASCII format. In some examples, only the authentication data and an 8-byte random number followed by MAC of the authentication data may be included. The authentication data may include an authentication challenge written to the contactless card by the client device. In some examples, the random number may precede cryptogram A and may be one block long. In other examples, there may be no restriction on the length of the random number. In further examples, the total data (i.e., the random number plus the cryptogram) may be a multiple of the block size. In these examples, an additional 8-byte block may be added to match the block produced by the MAC algorithm. As another example, if the algorithms employed used 16-byte blocks, even multiples of that block size may be used, or the output may be automatically, or manually, padded to a multiple of that block size.

The MAC may be performed by a function key (AUT-Session-Key) 1035. The data specified in cryptogram may be processed with javacard.signature method: ALG_DES_MAC8_ISO9797_1_M2_ALG3 to correlate to EMV ARQC verification methods. The key used for this computation may comprise a session key AUT-Session-Key 1035, as explained above. As explained above, the low order two bytes of the counter may be used to diversify for the one or more MAC session keys. As explained below, the AUT-Session-Key 1035 may be used to MAC data 1050, and the resulting data or cryptogram A 1055 and random number RND may be encrypted using DEK-Session-Key 1040 to create cryptogram B or output 1060 sent in the message. The MAC data 1050 may include an authentication challenge written to the contactless card by the client device. The authentication challenge may be generated by the client device or by the server.

In some examples, one or more HSM commands may be processed for decrypting such that the final 16 (binary, 32 hex) bytes may comprise a 3DES symmetric encrypting using CBC mode with a zero IV of the random number followed by MAC authentication data. The key used for this encryption may comprise a session key DEK-Session-Key 1040 derived from the Card-Key-DEK 1030. In this case, the ATC value for the session key derivation is the least significant byte of the counter pATC 1045.

The format below represents a binary version example embodiment. Further, in some examples, the first byte may be set to ASCII ‘A’.

Message Format

| | | | | |
|---|---|---|---|---|
| 1 | 2 | 4 | 8 | 8 |
| 0x43 (Message Type ‘A’) | Version | pATC | RND | Cryptogram A (MAC) |

| | |
|---|---|
| Cryptogram A (MAC) | 8 bytes |

Mac of

| | | | | |
|---|---|---|---|---|
| 2 | 8 | 4 | 4 | 18 bytes input data |
| Version | pUID | pATC | Shared Secret | |

Message Format

| | | | |
|---|---|---|---|
| 1 | 2 | 4 | 16 |
| 0x43 (Message Type ‘A’) | Version | pATC | Cryptogram B |
| Cryptogram A (MAC) | 8 bytes | | |

MAC of

| 2 | 8 | 4 | 4 | 18 bytes input data |
|---|---|---|---|---|
| Version | pUID | pATC | Shared Secret | |
| Cryptogram B | 16 | | | |
| Sym Encryption of | | | | |
| 8 | 8 | | | |
| RND | Cryptogram A | | | |

Another exemplary format is shown below. In this example, the tag may be encoded in hexadecimal format.

Message Format

| | | | | |
|---|---|---|---|---|
| 2 | 8 | 4 | 8 | 8 |
| Version | pUID | pATC | RND | Cryptogram A (MAC) |

8 bytes

| 8 | 8 | 4 | 4 | 18 bytes input data |
|---|---|---|---|---|
| pUID | pUID | pATC | Shared Secret | |

Message Format

| 2 | 8 | 4 | 16 |
|---|---|---|---|
| Version | pUID | pATC | Cryptogram B |
| 8 bytes | | | |

| 8 | | 4 | 4 | 18 bytes input data |
|---|---|---|---|---|
| pUID | pUID | pATC | Shared Secret | |

| Cryptogram B | 16 |
|---|---|
| Sym Encryption of | |
| 8 | 8 |
| RND | Cryptogram A |

The UID field (pUID/PSN 1020) of the received message may be extracted to derive, from master keys Iss-Key-AUTH 1005 and Iss-Key-DEK 1010, the card master keys (Card-Key-Auth 1025 and Card-Key-DEK 1030) for that particular card. Using the card master keys (Card-Key-Auth 1025 and Card-Key-DEK 1030), the counter (pATC) field of the received message may be used to derive the session keys (Aut-Session-Key 1035 and DEK-Session-Key 1040) for that particular card. The cryptogram B 1060 may be decrypted using the DEK-Session-KEY, which yields the cryptogram A 1055 and the RND, and the RND may be discarded. The UID field may be used to look up the shared secret of the contactless card which, along with the Ver, UID, the authentication challenge, and pATC fields of the message, may be processed through the cryptographic MAC using the re-created Aut-Session-Key to create a MAC output, such as MAC′. If the MAC′ is the same as the cryptogram A 1055, then this indicates that the message decryption and MAC checking have all passed. Then the pATC may be read to determine if it is valid, and/or the authentication challenge may be read to determine if it is valid by comparing it with the authentication challenge stored in the memory of the server or retrieved by the server from the database.

During an authentication session, one or more cryptograms may be generated by the one or more applications. For example, the one or more cryptograms may be generated as a 3DES MAC using ISO 9797-1 Algorithm 3 with Method 2 padding via one or more session keys, such as Aut-Session-Key 1035. The input data 1050 may take the following form: Version (2), pUID (8), pATC (4), Shared Secret (4), authentication challenge (4). In some examples, the numbers in the brackets may comprise length in bytes. In some examples, the shared secret may be generated by one or more random number generators which may be configured to ensure, through one or more secure processes, that the random number is unpredictable. In some examples, the authentication challenge may be included in the shared secret. In some examples, the shared secret may comprise a random 4-byte binary number injected into the card at personalization time that is known by the authentication service. During an authentication session, the shared secret may not be provided from the one or more applets to the mobile application. Method 2 padding may include adding a mandatory 0×‘80’ byte to the end of input data and 0×‘00’ bytes that may be added to the end of the resulting data up to the 8-byte boundary. The resulting cryptogram may comprise 8 bytes in length.

In some examples, one benefit of encrypting an unshared random number as the first block with the MAC cryptogram, is that it acts as an initialization vector while using CBC (Block chaining) mode of the symmetric encryption algorithm. This allows the “scrambling” from block to block without having to pre-establish either a fixed or dynamic IV.

By including the application transaction counter (pATC) as part of the data included in the MAC cryptogram, the authentication service may be configured to determine if the value conveyed in the clear data has been tampered with. Moreover, by including the version in the one or more cryptograms, it is difficult for an attacker to purposefully misrepresent the application version in an attempt to downgrade the strength of the cryptographic solution. In some examples, the pATC may start at zero and be updated by 1 each time the one or more applications generates authentication data. The authentication service may be configured to track the pATCs used during authentication sessions. In some examples, when the authentication data uses a pATC equal to or lower than the previous value received by the authentication service, this may be interpreted as an attempt to replay an old message, and the authentication may be rejected. In some examples, where the pATC is greater than the previous value received, this may be evaluated to determine if it is within an acceptable range or threshold, and if it exceeds or is outside the range or threshold, verification may be deemed to have failed or be unreliable. In the MAC operation 1036, data 1050 is processed through the MAC using Aut-Session-Key 1035 to produce MAC output (cryptogram A) 1055, which is encrypted.

In order to provide additional protection against brute force attacks exposing the keys on the card, it is desirable that the MAC cryptogram 1055 be enciphered. In some examples, data or cryptogram A 1055 to be included in the ciphertext may comprise: Random number (8), cryptogram (8). In some examples, the numbers in the brackets may comprise length in bytes. In some examples, the random number may be generated by one or more random number generators which may be configured to ensure, through one or more secure processes, that the random number is unpredictable. The key used to encipher this data may comprise a session key. For example, the session key may comprise DEK-Session-Key 1040. In the encryption operation 1041, data or cryptogram A 1055 and RND are processed using DEK-Session-Key 1040 to produce encrypted data, cryptogram B 1060. The data 1055 may be enciphered using 3DES in cipher block chaining mode to ensure that an attacker must run any attacks over all of the ciphertext. As a non-limiting example, other algorithms, such as Advanced Encryption Standard (AES), may be used. In some examples, an initialization vector of 0×‘0000000000000000’ may be used. Any attacker seeking to brute force the key used for enciphering this data will be unable to determine when the correct key has been used, as correctly decrypted data will be indistinguishable from incorrectly decrypted data due to its random appearance.

In order for the authentication service to validate the one or more cryptograms provided by the one or more applets, the following data must be conveyed from the one or more applets to the mobile/client device and/or the server in the clear during an authentication session: version number to determine the cryptographic approach used and message format for validation of the cryptogram, which enables the approach to change in the future; pUID to retrieve cryptographic assets, and derive the card keys; and pATC to derive the session key used for the cryptogram.

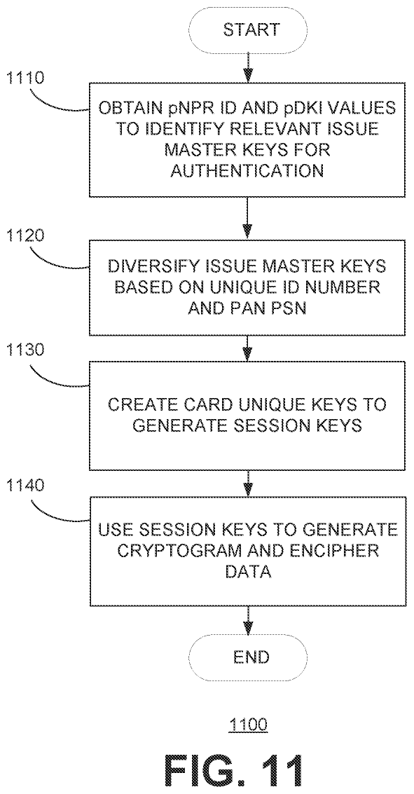

FIG. 11 illustrates a method 1100 for generating a cryptogram. For example, at block 1110, a network profile record ID (pNPR) and derivation key index (pDKI) may be used to identify which Issuer Master Keys to use in the cryptographic processes for authentication. In some examples, the method 1100 may include performing the authentication to retrieve values of pNPR and pDKI for a contactless card at the time of authentication.

At block 1120, Issuer Master Keys may be diversified by combining them with the card's unique ID number (pUID) and the PAN sequence number (PSN) of one or more applets, for example, a payment applet.

At block 1130, Card-Key-Auth and Card-Key-DEK (unique card keys) may be created by diversifying the Issuer Master Keys to generate session keys which may be used to generate a MAC cryptogram.

At block 1140, the keys used to generate the cryptogram and encipher the data in the one or more applets may comprise the session keys of block 1130 based on the card unique keys (Card-Key-Auth and Card-Key-DEK). In some examples, these session keys may be generated by the one or more applets and derived by using pATC, resulting in session keys Aut-Session-Key and DEK-Session-Key.

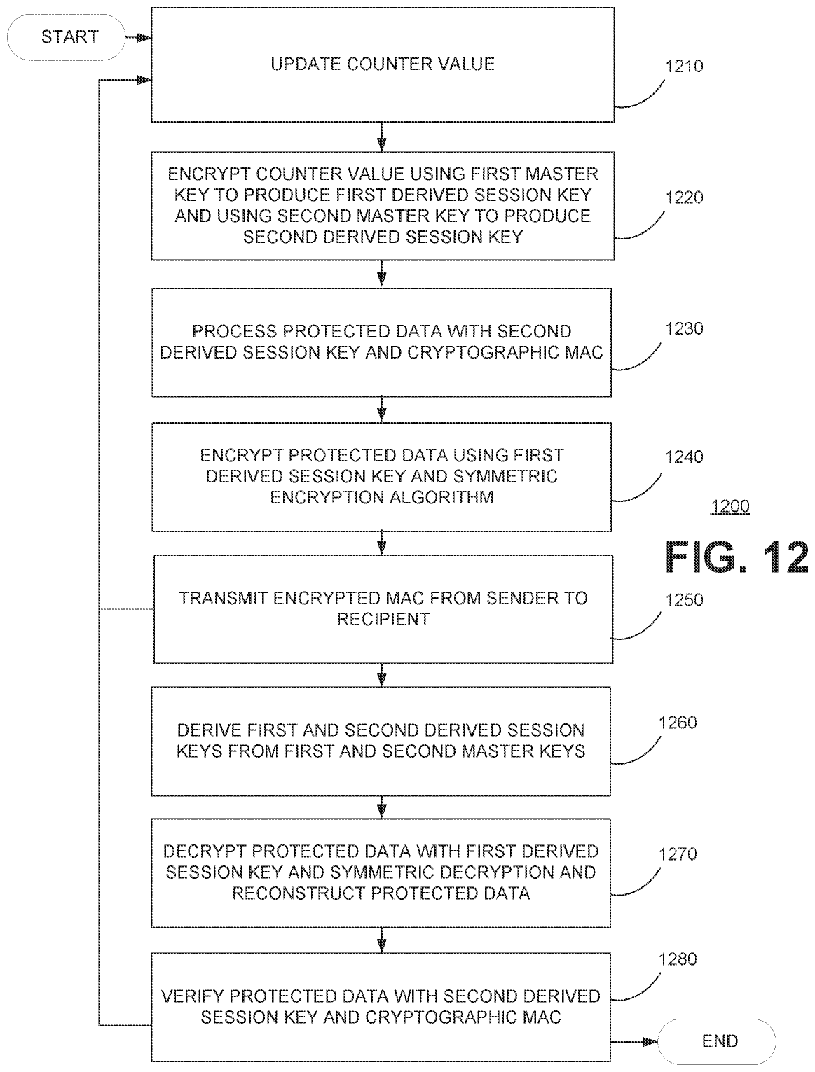

FIG. 12 depicts an exemplary process 1200 illustrating key diversification according to one example. Initially, a sender (a contactless card) and a recipient (a client device) may each be provisioned with two different master keys. For example, a first master key may comprise the data encryption master key, and a second master key may comprise the data integrity master key. The sender has a counter value, which may be updated at block 1210, and other data, such as data to be protected including an authentication challenge, which it may secure share with the recipient.

At block 1220, the counter value may be encrypted by the sender using the data encryption master key to produce the data encryption derived session key, and the counter value may also be encrypted by the sender using the data integrity master key to produce the data integrity derived session key. In some examples, a whole counter value or a portion of the counter value may be used during both encryptions.

In some examples, the counter value may not be encrypted. In these examples, the counter may be transmitted between the sender and the recipient in the clear, i.e., without encryption.

At block 1230, the data to be protected is processed with a cryptographic MAC operation by the sender using the data integrity session key and a cryptographic MAC algorithm. The protected data, including plaintext and shared secret, may be used to produce a MAC using one of the session keys (AUT-Session-Key).

At block 1240, the data to be protected (the MAC just produced) may be encrypted by the sender using the data encryption derived session key in conjunction with a symmetric encryption algorithm. In some examples, the MAC is combined with an equal amount of random data, for example each 8 bytes long, and then encrypted using the second session key (DEK-Session-Key).

At block 1250, the encrypted MAC is transmitted, from the sender to the recipient, with sufficient information to identify additional secret information (such as shared secret including the authentication challenge, master keys, etc.), for verification of the cryptogram.

At block 1260, the recipient uses the received counter value to independently derive the two derived session keys from the two master keys as explained above.

At block 1270, the data encryption derived session key is used in conjunction with the symmetric decryption operation to decrypt the protected data. Additional processing on the exchanged data will then occur. In some examples, after the MAC is extracted, it is desirable to reproduce and match the MAC. For example, when verifying the cryptogram, it may be decrypted using appropriately generated session keys. The protected data may be reconstructed for verification. A MAC operation may be performed using an appropriately generated session key to determine if it matches the decrypted MAC. As the MAC operation is an irreversible process, the only way to verify is to attempt to recreate it from source data.

At block 1280, the data integrity derived session key is used in conjunction with the cryptographic MAC operation to verify that the protected data has not been modified. If the reconstructed MAC from the MAC operation matches the decrypted MAC, then the decrypted MAC is verified and the protected data including the authentication challenge are validated. In addition, the authentication challenge included in the MAC transmitted from the sender may be compared with the authentication challenge stored in the server to determine whether they match.

Some examples of the methods described herein may advantageously confirm when a successful authentication is determined when the following conditions are met. First, the ability to verify the MAC shows that the derived session key was proper. The MAC may only be correct if the decryption was successful and yielded the proper MAC value. The successful decryption may show that the correctly derived encryption key was used to decrypt the encrypted MAC. Since the derived session keys are created using the master keys known only to the sender (e.g., the transmitting device) and recipient (e.g., the receiving device), it may be trusted that the contactless card which originally created the MAC and encrypted the MAC is indeed authentic. Moreover, the counter value used to derive the first and second session keys may be shown to be valid and may be used to perform authentication operations. Further, the MAC may only be correct and verified when the authentication challenge included in the MAC matches the authentication challenge used by the authentication service (such as the server).

Thereafter, the two derived session keys may be discarded, and the next iteration of data exchange will update the counter value (returning to block 1210) and a new set of session keys may be created (at block 1220). In some examples, the combined random data may be discarded. Further, a different authentication challenge may be generated by the authentication service (e.g., the server or the client device) and written into the contactless card by the client device for the next iteration of data exchange.

Example embodiments of systems and methods described herein may be configured to provide security factor authentication. The security factor authentication may comprise a plurality of processes. As part of the security factor authentication, a first process may comprise logging in and validating a user via one or more applications executing on a device. As a second process, the user may, responsive to successful login and validation of the first process via the one or more applications, engage in one or more behaviors associated with one or more contactless cards. In effect, the security factor authentication may include both securely proving identity of the user and engaging in one or more types of behaviors, including but not limited to one or more tap gestures, associated with the contactless card. In some examples, the one or more tap gestures may comprise a tap of the contactless card by the user to a device. In some examples, the device may comprise a mobile device, a kiosk, a terminal, a tablet, or any other device configured to process a received tap gesture.

In some examples, the contactless card may be tapped to a device, such as one or more computer kiosks or terminals, to verify identity so as to receive a transactional item responsive to a purchase, such as a coffee. By using the contactless card, a secure method of proving identity in a loyalty program may be established. Securely proving the identity, for example, to obtain a reward, coupon, offer, or the like or receipt of a benefit is established in a manner that is different than merely scanning a bar card. For example, an encrypted transaction may occur between the contactless card and the device, which may be configured to process one or more tap gestures. As explained above, the one or more applications may be configured to validate identity of the user and then cause the user to act or respond to it, for example, via one or more tap gestures. In some examples, data for example, bonus points, loyalty points, reward points, healthcare information, etc., may be written back to the contactless card.

In some examples, the contactless card may be tapped to a device, such as a mobile device. As explained above, identity of the user may be verified by the one or more applications which would then grant the user a desired benefit based on verification of the identity.

In some examples, the contactless card may be activated by tapping to a device, such as a mobile device. For example, the contactless card may communicate with an application of the device via a card reader of the device through NFC communication. The communication, in which a tap of the card proximate the card reader of the device may allow the application of the device to read data associated with the contactless card and activate the card. In some examples, the activation may authorize the card to be used to perform other functions, e.g., purchases, access account or restricted information, or other functions. In some examples, the tap may activate or launch the application of the device and then initiate one or more actions or communications with one or more servers to activate the contactless card. If the application is not installed on the device, a tap of the contactless card proximate the card reader may initiate a download of the application, such as navigation to a download page of the application). Subsequent to installation, a tap of the contactless card may activate or launch the application, and then initiate, for example via the application or other back-end communication, activation of the contactless card. After activation, the contactless card may be used in various activities, including without limitation commercial transactions.

In some embodiments, the example authentication communication protocol may mimic an offline dynamic data authentication protocol of the EMV standard that is commonly performed between a transaction card and a point-of-sale device, with some modifications. For example, because the example authentication protocol is not used to complete a payment transaction with a card issuer/payment processor per se, some data values are not needed, and authentication may be performed without involving real-time online connectivity to the card issuer/payment processor. As is known in the art, point of sale (POS) systems submit transactions including a transaction value to a card issuer. Whether the issuer approves or denies the transaction may be based on if the card issuer recognizes the transaction value. Meanwhile, in certain embodiments of the present disclosure, transactions originating from a mobile device lack the transaction value associated with the POS systems. Therefore, in some embodiments, a dummy transaction value (i.e., a value recognizable to the card issuer and sufficient to allow activation to occur) may be passed as part of the example authentication communication protocol. POS based transactions may also decline transactions based on the number of transaction attempts (e.g., transaction counter). A number of attempts beyond a buffer value may result in a soft decline; the soft decline requiring further verification before accepting the transaction. In some implementations, a buffer value for the transaction counter may be modified to avoid declining legitimate transactions.

In some examples, the contactless card can selectively communicate information depending upon the recipient device. Once tapped, the contactless card can recognize the device to which the tap is directed, and based on this recognition the contactless card can provide appropriate data for that device. This advantageously allows the contactless card to transmit only the information required to complete the instant action or transaction, such as a payment or card authentication. By limiting the transmission of data and avoiding the transmission of unnecessary data, both efficiency and data security can be improved. The recognition and selective communication of information can be applied to a various scenarios, including card activation, balance transfers, account access attempts, commercial transactions, and step-up fraud reduction.

If the contactless card tap is directed to a device running Apple's iOS® operating system, e.g., an iPhone, iPod, or iPad, the contactless card can recognize the iOS® operating system and transmit appropriate data to communicate with this device. For example, the contactless card can provide the encrypted identity information necessary to authenticate the card using NDEF tags via, e.g., NFC. Similarly, if the contactless card tap is directed to a device running the Android® operating system, e.g., an Android® smartphone or tablet, the contactless card can recognize the Android® operating system and transmit appropriate data to communicate with this device (such as the encrypted identity information necessary for authentication by the methods described herein).

As another example, the contactless card tap can be directed to a POS device, including without limitation a kiosk, a checkout register, a payment station, or other terminal. Upon performance of the tap, the contactless card can recognize the POS device and transmit only the information necessary for the action or transaction. For example, upon recognition of a POS device used to complete a commercial transaction, the contactless card can communicate payment information necessary to complete the transaction under the EMV standard.

In some examples, the POS devices participating in the transaction can require or specify additional information, e.g., device-specific information, location-specific information, and transaction-specific information, that is to be provided by the contactless card. For example, once the POS device receives a data communication from the contactless card, the POS device can recognize the contactless card and request the additional information necessary to complete an action or transaction.

In some examples the POS device can be affiliated with an authorized merchant or other entity familiar with certain contactless cards or accustomed to performing certain contactless card transactions. However, it is understood such an affiliation is not required for the performance of the described methods.

In some examples, such as a shopping store, grocery store, convenience store, or the like, the contactless card may be tapped to a mobile device without having to open an application, to indicate a desire or intent to utilize one or more of reward points, loyalty points, coupons, offers, or the like to cover one or more purchases. Thus, an intention behind the purchase is provided.

In some examples, the one or more applications may be configured to determine that it was launched via one or more tap gestures of the contactless card, such that a launch occurred at 3:51 pm, that a transaction was processed or took place at 3:56 pm, in order to verify identity of the user.

In some examples, the one or more applications may be configured to control one or more actions responsive to the one or more tap gestures. For example, the one or more actions may comprise collecting rewards, collecting points, determine the most important purchase, determine the least costly purchase, and/or reconfigure, in real-time, to another action.

In some examples, data may be collected on tap behaviors as biometric/gestural authentication. For example, a unique identifier that is cryptographically secure and not susceptible to interception may be transmitted to one or more backend services. The unique identifier may be configured to look up secondary information about individual. The secondary information may comprise personally identifiable information about the user. In some examples, the secondary information may be stored within the contactless card.

In some example embodiments, a client/user device (such as a mobile phone) may have full read/write capabilities for NDEF. This can make a contactless card compatible with the client device that has full read/write capabilities for NDEF while also maintaining backward compatibility for client devices that have read-only access to NDEF via NFC. The card/bank application can detect if the client device's operating system and hardware are able to do full NDEF file read/write. When a write is possible, the client device can write an authentication challenge (such as a randomly generated number) to the contactless card. This authentication challenge is then used in the cryptogram calculation. A timestamp can also be added to further enhance the cryptography. The cryptogram is calculated and passed back to the server side validation system which also has the random number and/or the timestamp. The server side validation system as the backend can be flexible enough to recognize read-only card cryptograms and read/write card cryptograms. Both can then be validated by the backend, and the validation can be sent to the client device to authenticate against the specified customer use cases.

With an authentication challenge written into a contactless card, data transmission can be further secured. For example, a random number as an authentication challenge can be written by a client device into the contactless card, the server validation system gets a response back from the contactless card that is digitally signed or mapped with that random number, and then the server validation system can verify if that happened within that session. In such embodiments, the application that is submitting the response cryptogram message to the server validation system (i.e., a validator) first determines whether or not the client device is capable of doing a NDEF file write. If it is capable of doing this low-level write, the authentication challenge can be sent to the contactless card as an additional operation inserted into the normal NDEF read streams. One or more applets may be required for the contactless card for such functionalities. The applet can allow an authentication challenge into the contactless card and then to be incorporated into the MAC cryptogram for the NFC read. If the client device is a non-write capable device, the applet can allow zeros into the contactless card and then to be incorporated into the MAC cryptogram for the NFC read, or no zeros in and zeros can be the default for the contactless card. In such cases, zeros may be added to the MAC cryptogram message and then the client device and/or the server can determine that an authentication challenge cannot be transmitted to the contactless card from the back end and the server side validation system can validate the MAC cryptogram message assuming zeros being incorporated in the MAC cryptogram.

With an authentication challenge written into a contactless card by a client device and incorporated into a MAC cryptogram message by the contactless card, data security can be significantly enhanced. Each time when the contactless card is read via NFC, the authentication challenge incorporated in the MAC cryptogram message is different for that read session. For example, if a hacker records a MAC cryptogram message and then replays it later, the server side validation system would be expecting a MAC cryptogram response incorporating an authentication challenge different than the authentication challenge replayed by the hacker, the MAC cryptogram message replayed by the hacker would not be verified by the server side validation system. That is, each time when the contactless card is read, a new authentication challenge would be written into the contactless card and incorporated into the MAC cryptogram to overwrite the old authentication challenge. By default, the authentication challenge used by the contactless card would be zeros. Therefore, if no authentication challenge is transmitted to the contactless card, the contactless card would just always include zeros in the MAC cryptogram message. For a contactless card to accept an authentication challenge, the applets or the algorithm may need an additional interface that can accept this authentication challenge and then write it into the NDEF message. The contactless card incorporates this authentication challenge in the MAC cryptogram and encrypts this authentication challenge in the algorithm, and then the backend sever knows this authentication challenge that was used in order to validate that MAC cryptogram.

In this way, replay attacks on data may be prevented. If a contactless card relies on one-time password such as a counter for authentication the card, the counter goes up for each card reading, and then the server has to keep track of what the last counter that was validated is used. If that counter is out of a certain window-such as any counters that are less than the current counter, the MAC response would be rejected by the server. However, the problem is that for example, when a hacker takes the card and reads a thousand MAC cryptograms from the card, it may be unlikely that the card will be used by the card's owner to do authentications in the next day or an hour. So now the hacker can then go and take those MAC cryptograms and submit those MAC cryptograms from another place, which may be called replay attacks. To prevent such replay attacks, authentication challenge response mechanism disclosed above can be used as an additional factor for authenticating the card, whereby improving data security, because with the authentication challenge response mechanism performed, the server would expect a challenge included in the MAC cryptogram for each reading session, the MAC cryptograms replayed by the hacker will not work due to lack of authentication challenges.

The authentication challenge may be a random number (i.e., a 4-digit number) that may be either a binary number or an ASCII text. It can be anything random that may then be incorporated in the MAC message. When reading or authenticating a contactless card, the backend server may generate an authentication challenge and send it to a client device that is doing the reading. The client device may then transmit/write this challenge to the contactless card and start the card read. The card may then do the select applet, select capabilities container, submit this challenge, read the data file, and return a MAC cryptogram with this challenge included in it.

In some embodiments, the client device may communicate via API with the server to perform some dialogue between the client device and the server. For example, if a contactless card has an older version of the applet that does not support authentication challenges, the client device may then return this older version number of the applet to the server, and that version number may be processed differently by the server. At the same time, the client device can also communicate back to the server that the authentication challenge was not capable of being carried out and the MAC message should be processed in a read-only manner.

With the authentication challenge response mechanism disclosed herein, the card applet does not perform just the selects and reads operations, it also performs a write operation of writing an authentication challenge into a field of NDEF tag, which is a different APDU. They start with a class and instruction byte. That instruction byte then is just interpreted by the applet that would be implementing this protocol. And another instruction is added to the APDU that would be interpreted by the process function of the applet. Each time an authentication challenge is requested, the server may be asked to generate a random number and then send the random number to the client device that performs reading the card and writing the random number to the card. Alternatively, the client device can also actually generate the random number and then transmit it back to the server to let the server know. The server would keep track that the random number has not been reused in that case. So the server would have to make sure that the random number had not been reused recently. For example, the server may store the random numbers already generated in a database and look them up against a random number to determine whether the random number had been used before or recently (such as in the last ten times or in the last two weeks).

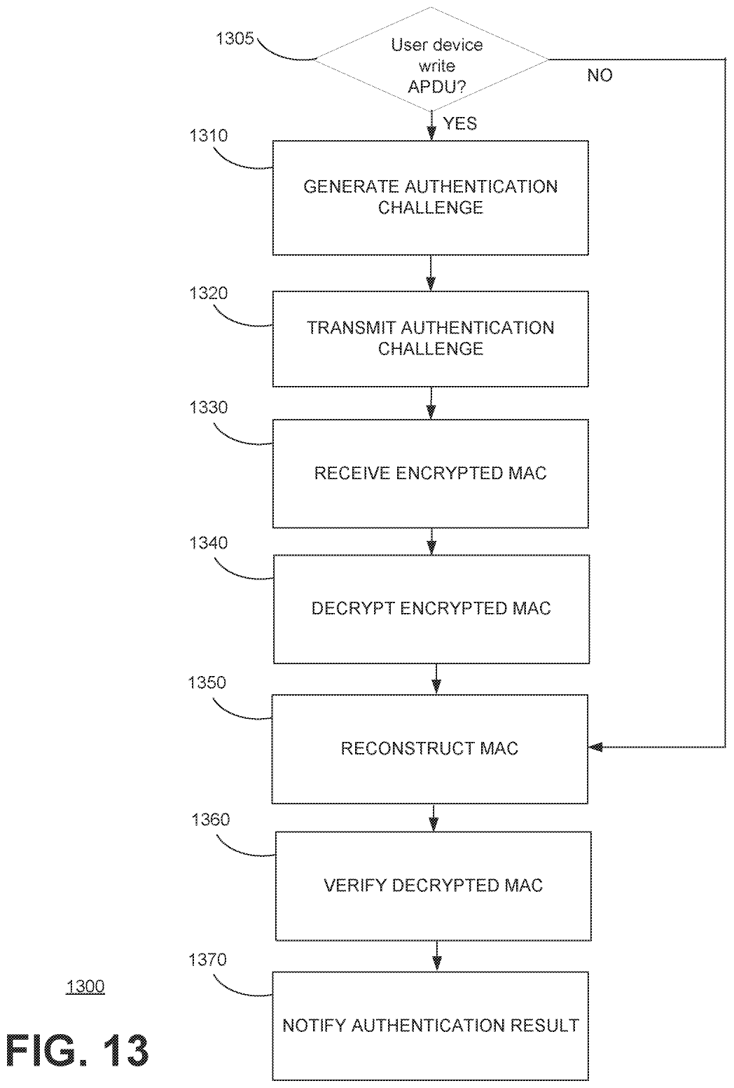

FIG. 13 is a flowchart illustrating a method 1300 for secure authentication of a contactless card according to an example embodiment. In step 1305, a user/client device is determined whether it is capable of performing a write function into NDEF tag of a contactless card. This can be determined by a bank application installed on the user device, for example through checking the OS and hardware of the user device via API. When the user device is determined to be capable of performing a write function into NDEF tag of the contactless card (the “YES” branch is selected), in step 1310, an authentication challenge is generated by the server when a request for generating the authentication challenge is transmitted from the user device to the server each time the contactless card is read via NFC. The user device may also communicate with the server to let the server know whether it is capable of performing a write into the card based on the determination results in step 1305. In step 1320, the server transmit the generated authentication challenge to the user device, for example via API, or a network. In step 1330, the server receives an encrypted MAC message from the user device. When the card receives the authentication challenge from the user device, the card generates an encrypted MAC cryptogram incorporating the authentication challenge as described above, and then transmits the encrypted MAC cryptogram message to the user device, which subsequently sends to the server. In step 1340, the server decrypts the encrypted MAC message, for example, using one of session keys as described above, to retrieve the MAC cryptogram generated by the card using another session key. In step 1350, the server may reconstruct a MAC cryptogram incorporating the authentication challenge using another session key, as described above. In step 1360, the server may verify the MAC cryptogram received from the card. For example, the server compares the MAC cryptogram reconstructed by the server with the MAC cryptogram generated by and received from the card. If the two MAC cryptograms match each other, then the MAC cryptogram generated by and received from the card is verified and authenticated. In step 1370, the sever may notify the user device of the authentication result. For example, the server may transmit to the user device a notification message indicating that the card has been authenticated successfully.

In addition, when the user device is determined not to be capable of performing a write function into NDEF tag of the contactless card (the “NO” branch is selected), the method 1300 may move to the step 1350. In this scenario, no authentication challenge is generated by the server or the user device, that is, no authentication challenge is transmitted/written to the card. The card would use the default zeros to generate a MAC cryptogram. The server also reconstructs a MAC cryptogram incorporating zeros as default values.

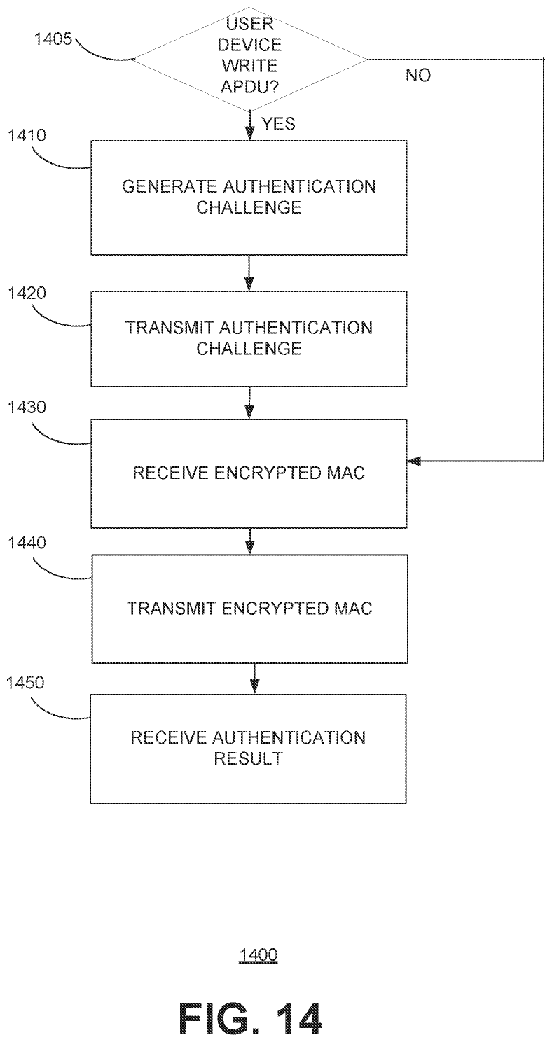

FIG. 14 is a flowchart illustrating a method 1400 for secure authentication of a contactless card according to an example embodiment. In step 1405, a user/client device is determined whether it is capable of performing a write function into NDEF tag of a contactless card. This can be determined by a bank application installed on the user device, for example through checking the OS and hardware of the user device via API. When the user device is determined to be capable of performing a write function into NDEF tag of the contactless card (the “YES” branch is selected), in step 1410, an authentication challenge is generated by the user device when each time the contactless card is read via NFC. The user device may also communicate with the server to let the server know whether it is capable of performing a write into the card based on the determination results in step 1305. In step 1420, the user device transmits the generated authentication challenge to the card and the server, for example via API, or a network. In step 1430, the user device receives an encrypted MAC message from the card. When the card receives the authentication challenge from the user device, the card generates an encrypted MAC cryptogram incorporating the authentication challenge as described above, and then transmits the encrypted MAC cryptogram message to the user device. In step 1440, the user device subsequently sends the encrypted MAC cryptogram message to the server. The server decrypts the encrypted MAC message, for example, using one of session keys as described above, to retrieve the MAC cryptogram generated by the card using another session key. The server may reconstruct a MAC cryptogram incorporating the authentication challenge using another session key, as described above. The server may verify the MAC cryptogram received from the card. For example, the server compares the MAC cryptogram reconstructed by the server with the MAC cryptogram generated by and received from the card. If the two MAC cryptograms match each other, then the MAC cryptogram generated by and received from the card is verified and authenticated. The sever may notify the user device of the authentication result. For example, the server may transmit to the user device a notification message indicating that the card has been authenticated successfully. In step 1450, the user device may then receive the authentication results from the server.

In addition, when the user device is determined not to be capable of performing a write function into NDEF tag of the contactless card (the “NO” branch is selected), the method 1400 may move to the step 1430. In this scenario, no authentication challenge is generated by the user device, that is, no authentication challenge is transmitted/written to the card. The card would use the default zeros to generate a MAC cryptogram. The server also reconstructs a MAC cryptogram incorporating zeros as default values. In step 1430, the user device receives MAC cryptogram generated by the card using the default zeros, and then send it to the server.

In some embodiments, a timestamp may be generated and associated with an authentication challenge. The timestamp indicates a time when the authentication challenge is generated. The timestamp may be transmitted and written to the card along with the associated authentication challenge. If the timestamp and its associated authentication challenge are generated by the client device, the client device may transmit the timestamp and its associated authentication challenge to the server. The server may validate the card base on both the authentication challenge and the timestamp.

As disclosed herein, a secure authentication system is provided. The secure authentication system comprises: a first device (e.g., a contactless card) having a processor and memory, the memory of the first device containing a master key and a counter value; a second device (e.g., a user/client device) having a processor and memory and in data communication with the first device via a first network; and a server having a processor and memory and in data communication with the second device via a second network, the server configured to generate an authentication challenge and transmit the authentication challenge to the second device via the second network, and the memory of the server containing the master key and the authentication challenge. The first device is configured to: receive, via the first network from the second device, the authentication challenge; generate a session key using the master key and one or more cryptographic algorithms and store the session key in the memory of the first device; generate a message authentication code (MAC) over the counter value and the authentication challenge using the one or more cryptographic algorithms and the session key; encrypt the MAC using the one or more cryptographic algorithms to yield an encrypted MAC cryptogram; and transmit the encrypted MAC cryptogram to the second device via the first network. The second device is configured to: receive, via the second network from the server, the authentication challenge; transmit, via the first network to the first device, the authentication challenge; receive, via the first network from the first device, the encrypted MAC cryptogram; and transmit, via the second network to the server, the encrypted MAC cryptogram. The server is configured to: generate the session key based on the master key, and store the session key in the memory of the server; receive, via the second network from the second device, the encrypted MAC cryptogram; decrypt the encrypted MAC cryptogram using the one or more cryptographic algorithms and the session key; and validate the authentication challenge.

In the secure authentication system, the first network is a near field communication (NFC) network. The authentication challenge comprises a random number, a binary number, or an ASCII text. The second device is configured to transmit, via the first network to the first device, the authentication challenge to write the authentication challenge in APDU format into a NDEF file stored in the memory of the first device. The second device is further configured to: generate the authentication challenge; and transmit, via the second network to the server, the authentication challenge. The second device is further configured to determine whether the second device is capable of transmitting the authentication challenge to the first device in APDU format. The authentication challenge is set as a default value of zero when the second device is determined not to be capable of transmitting the authentication challenge to the first device in APDU format. The server is further configured to generate a timestamp associated with the authentication challenge and validate the authentication challenge based on the timestamp. The one or more cryptographic algorithms comprise at least one of a symmetric encryption algorithm, an HMAC algorithm, and a CMAC algorithm. The counter value comprises a one-time passcode. The master key is limited to a predetermined number of uses. The master key is limited to use during a predetermined time period.

As disclosed herein, a secure authentication method is also provided. The method may comprise: generating, by a server, an authentication challenge, wherein the server is configured to have a memory containing a master key and the authentication challenge; transmitting, by the server, the authentication challenge to a client device; generating, by the server, a session key based on the master key, and storing the session key in the memory of the server; receiving, by the server from the client device, an encrypted message authentication code (MAC) cryptogram; decrypting, by the server, the encrypted MAC cryptogram using one or more cryptographic algorithms and the session key; and validating, by the server, the card and/or the authentication challenge.

In the method, the encrypted MAC cryptogram is generated by a contactless card. The contactless card is configured to have a processor and memory containing the master key and a counter value, the contactless card configured to: receive, via a NFC network from the client device, the authentication challenge; generate the session key using the master key and the one or more cryptographic algorithms and store the session key in the memory of the contactless card; generate the MAC over the counter value and the authentication challenge using the one or more cryptographic algorithms and the session key; encrypt the MAC using the one or more cryptographic algorithms to yield the encrypted MAC cryptogram; and transmit the encrypted MAC cryptogram to the client device via the NFC network. The memory of the contactless card further contains an applet, a shared secret, and a unique identification number associated with the contactless card, and the encrypted MAC cryptogram comprises one or more of the unique identification number, the counter value, a version number of the applet, the authentication challenge, and the shared secret. The authentication challenge is updated each time the session key is generated. The contactless card is configured to have a radio frequency identification chip and transmit at least one of the unique identification number, the counter value, and the version number of the applet to the client device via near field communication. The master key is generated using a network profile record identifier and a derivation key index.

As disclosed herein, a contactless card may be provided. The contactless card may comprise: a memory containing one or more applets, a counter value, and a plurality of keys; a communication interface; and one or more processors in communication with the memory and communication interface. The one or more processors is configured to receive an authentication challenge and update the counter value when the communication interface is within a range of a communication field of a client device. The one or more processors is configured to create an encrypted MAC cryptogram using the plurality of keys, the authentication challenge, and the counter value. The encrypted MAC cryptogram is transmitted, via the communication interface, to the client device.

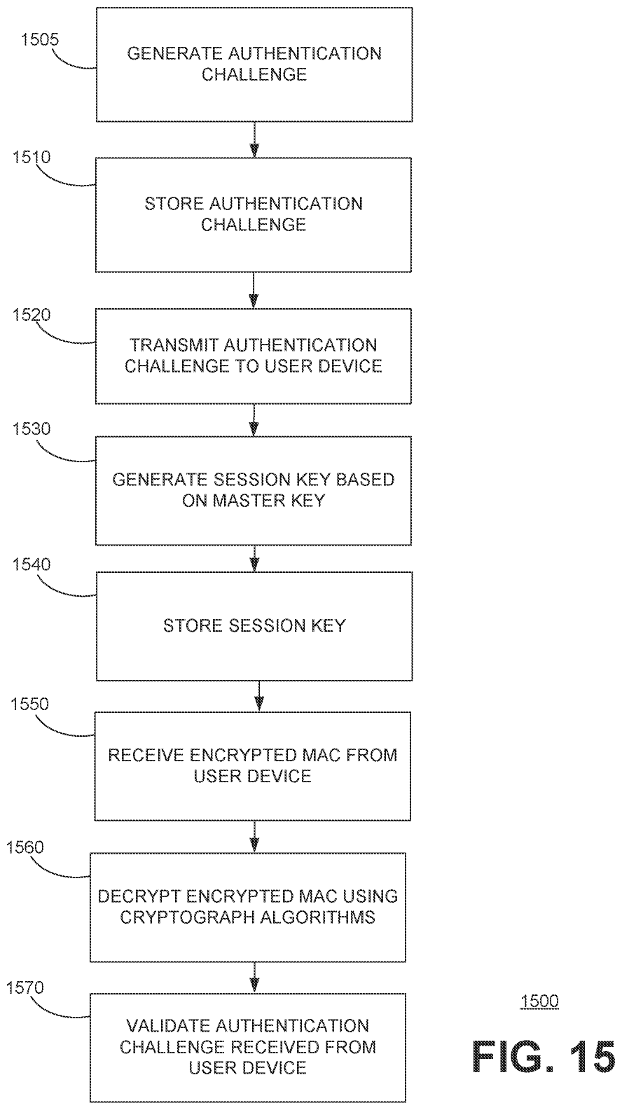

FIG. 15 is a flowchart illustrating a method 1500 for secure authentication of a contactless card, which can be executed by a server, according to an example embodiment. The server may comprise a processor and a memory. By executing the method 1500, the server may be configured to: generate an authentication challenge (step 1505); store the authentication challenge in the memory (step 1510); transmit the authentication challenge to a user device (step 1520); generate a session key based on a master key (step 1530); store the session key in the memory (step 1540); receive from the user device, an encrypted message authentication code (MAC) cryptogram incorporating the authentication challenge (step 1550); decrypt the encrypted MAC cryptogram using one or more cryptographic algorithms and the session key (step 1560); and validate the authentication challenge received from the user device (step 1570). The authentication challenge comprises a random number, a binary number, or an ASCII text. The authentication challenge is set as a default value of zero when the user device is determined not to be capable of writing the authentication challenge into a contactless card in APDU format. The server is further configured to generate a timestamp associated with the authentication challenge and validate the authentication challenge based on the timestamp. The one or more cryptographic algorithms comprise at least one of a symmetric encryption algorithm, an HMAC algorithm, and a CMAC algorithm. The encrypted MAC cryptogram incorporates the authentication challenge. The server is further configured to: reconstruct an MAC cryptogram incorporating the authentication challenge; and compare the reconstructed MAC cryptogram with the decrypted MAC cryptogram, wherein the authentication challenge is validated if the reconstructed MAC cryptogram matches the decrypted MAC cryptogram.

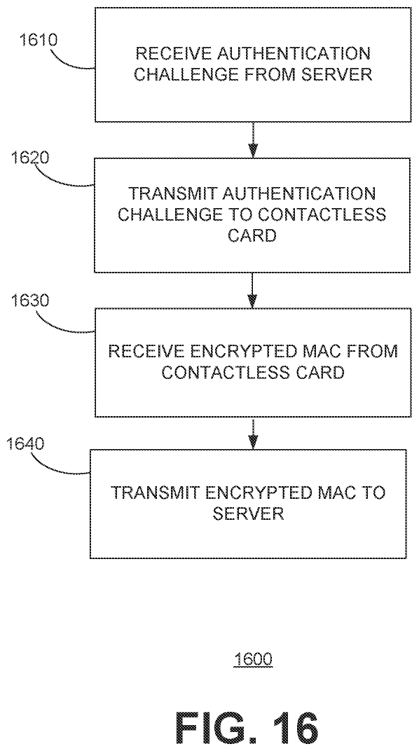

FIG. 16 is a flowchart illustrating a method 1600 for secure authentication of a contactless card, which can be executed by a user device, according to an example embodiment. The user device may comprise a processor and a memory. When executing the method 1600, the user device is configured to: receive from a server, an authentication challenge (step 1610); transmit, to a contactless card, the authentication challenge (step 1620); receive from the contactless card, an encrypted MAC cryptogram (step 1630); and transmit to the server, the encrypted MAC cryptogram (step 1640). The encrypted MAC cryptogram is generated by the contactless card based on the authentication challenge. The user device is further configured to write the authentication challenge in APDU format into a NDEF file stored in the contactless card. The user device is further configured to generate the authentication challenge. The user device is further configured to determine whether the user device is capable of writing the authentication challenge into the contactless card in APDU format. The authentication challenge is set as a default value of zero when the second device is determined not to be capable of writing the authentication challenge into the contactless card in the APDU format. The user device is further configured to receive from the server a notification indicating that the authentication challenge is validated. The encrypted MAC cryptogram is received from the contactless card through a near field communication (NFC).

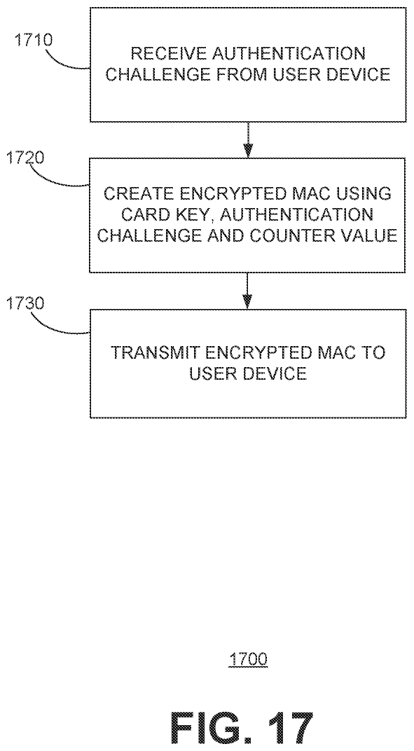

FIG. 17 is a flowchart illustrating a method 1700 for secure authentication of a contactless card, which can be executed by a contactless card, according to an example embodiment. The contactless card may comprise: a memory containing a counter value and a card key; a communication interface; and a processor in communication with the memory and communication interface. By executing the method 1700, the processors is configured to: receive an authentication challenge from a user device when the communication interface is within a range of a communication field of the user device (step 1710), create an encrypted MAC cryptogram using the card key, the authentication challenge, and the counter value (step 1720), and transmit the encrypted MAC cryptogram, via the communication interface, to the user device (step 1730). The authentication challenge is set as a default value of zero when the user device is determined not to be capable of writing the authentication challenge to the contactless in APDU format. The encrypted MAC cryptogram is encrypted using one or more cryptographic algorithms comprising at least one of a symmetric encryption algorithm, an HMAC algorithm, and a CMAC algorithm. The processor is configured to update the counter value when the communication interface is within the range of the communication field of the user device, the counter value comprising a one-time passcode. The card key is limited to a predetermined number of uses.

In some aspects, the techniques described herein relate to a secure authentication system including a server including a processor and a memory, the server configured to: generate an authentication challenge; store the authentication challenge in the memory; transmit the authentication challenge to a user device; generate a session key based on a master key; store the session key in the memory; receive from the user device, an encrypted message authentication code (MAC) cryptogram incorporating the authentication challenge; decrypt the encrypted MAC cryptogram using one or more cryptographic algorithms and the session key; and validate the authentication challenge received from the user device.

In some aspects, the techniques described herein relate to a secure authentication system, wherein the authentication challenge includes a random number, a binary number, or an ASCII text.

In some aspects, the techniques described herein relate to a secure authentication system, wherein the authentication challenge is set as a default value of zero when the user device is determined not to be capable of writing the authentication challenge into a contactless card in APDU format.

In some aspects, the techniques described herein relate to a secure authentication system, wherein the server is further configured to generate a timestamp associated with the authentication challenge and validate the authentication challenge based on the timestamp.

In some aspects, the techniques described herein relate to a secure authentication system, wherein the one or more cryptographic algorithms include at least one of a symmetric encryption algorithm, an HMAC algorithm, and a CMAC algorithm.

In some aspects, the techniques described herein relate to a secure authentication system, wherein the encrypted MAC cryptogram incorporates the authentication challenge.

In some aspects, the techniques described herein relate to a secure authentication system, wherein the server is further configured to: reconstruct an MAC cryptogram incorporating the authentication challenge; and compare the reconstructed MAC cryptogram with the decrypted MAC cryptogram, wherein the authentication challenge is validated if the reconstructed MAC cryptogram matches the decrypted MAC cryptogram.

In some aspects, the techniques described herein relate to a secure authentication system including: a user device including a processor and a memory, wherein the user device is configured to: receive from a server, an authentication challenge; transmit, to a contactless card, the authentication challenge; receive from the contactless card, an encrypted MAC cryptogram; and transmit to the server, the encrypted MAC cryptogram.

In some aspects, the techniques described herein relate to a secure authentication system, wherein the encrypted MAC cryptogram is generated by the contactless card based on the authentication challenge.

In some aspects, the techniques described herein relate to a secure authentication system, wherein the user device is further configured to write the authentication challenge in APDU format into a NDEF file stored in the contactless card.

In some aspects, the techniques described herein relate to a secure authentication system, wherein the user device is further configured to generate the authentication challenge.

In some aspects, the techniques described herein relate to a secure authentication system, wherein the user device is further configured to determine whether the user device is capable of writing the authentication challenge into the contactless card in APDU format.

In some aspects, the techniques described herein relate to a secure authentication system, wherein the authentication challenge is set as a default value of zero when the user device is determined not to be capable of writing the authentication challenge into the contactless card in the APDU format.

In some aspects, the techniques described herein relate to a secure authentication system, wherein the user device is further configured to receive from the server a notification indicating that the authentication challenge is validated.

In some aspects, the techniques described herein relate to a secure authentication system, wherein the encrypted MAC cryptogram is received from the contactless card through a near field communication (NFC).

In some aspects, the techniques described herein relate to a contactless card including: a memory containing a counter value and a card key; a communication interface; and a processor in communication with the memory and communication interface, wherein the processors is configured to: receive an authentication challenge from a user device when the communication interface is within a range of a communication field of the user device, create an encrypted MAC cryptogram using the card key, the authentication challenge, and the counter value, and transmit the encrypted MAC cryptogram, via the communication interface, to the user device.

In some aspects, the techniques described herein relate to a contactless card, wherein the authentication challenge is set as a default value of zero when the user device is determined not to be capable of writing the authentication challenge to the contactless in APDU format.

In some aspects, the techniques described herein relate to a contactless card, wherein the encrypted MAC cryptogram is encrypted using one or more cryptographic algorithms including at least one of a symmetric encryption algorithm, an HMAC algorithm, and a CMAC algorithm.

In some aspects, the techniques described herein relate to a contactless card, wherein the processor is configured to update the counter value when the communication interface is within the range of the communication field of the user device, the counter value including a one-time passcode.

In some aspects, the techniques described herein relate to a contactless card, wherein the card key is limited to a predetermined number of uses.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, and any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “some examples,” “other examples,” “one example,” “an example,” “various examples,” “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrases “in one example,” “in one embodiment,” or “in one implementation” does not necessarily refer to the same example, embodiment, or implementation, although it may.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, including the best mode, and also to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A secure authentication system comprising a server including a processor and a memory, the server configured to:
generate an authentication challenge;
store the authentication challenge in the memory;
transmit the authentication challenge to a user device;
generate a session key based on a master key;
store the session key in the memory;
receive from the user device, an encrypted message authentication code (MAC) cryptogram incorporating the authentication challenge;
decrypt the encrypted MAC cryptogram using one or more cryptographic algorithms and the session key; and
validate the authentication challenge received from the user device.

2. The secure authentication system of claim 1, wherein the authentication challenge comprises a random number, a binary number, or an ASCII text.

3. The secure authentication system of claim 1, wherein the authentication challenge is set as a default value of zero when the user device is determined not to be capable of writing the authentication challenge into a contactless card in APDU format.

4. The secure authentication system of claim 1, wherein the server is further configured to generate a timestamp associated with the authentication challenge and validate the authentication challenge based on the timestamp.

5. The secure authentication system of claim 1, wherein the one or more cryptographic algorithms comprise at least one of a symmetric encryption algorithm, an HMAC algorithm, and a CMAC algorithm.

6. The secure authentication system of claim 1, wherein the encrypted MAC cryptogram incorporates the authentication challenge.

7. The secure authentication system of claim 1, wherein the server is further configured to:
reconstruct an MAC cryptogram incorporating the authentication challenge; and
compare the reconstructed MAC cryptogram with the decrypted MAC cryptogram,
wherein the authentication challenge is validated if the reconstructed MAC cryptogram matches the decrypted MAC cryptogram.

8. A secure authentication system comprising:
a user device comprising a processor and a memory,
wherein the user device is configured to:
receive from a server, an authentication challenge;
transmit, to a contactless card, the authentication challenge;
receive from the contactless card, an encrypted MAC cryptogram; and
transmit to the server, the encrypted MAC cryptogram.

9. The secure authentication system of claim 8, wherein the encrypted MAC cryptogram is generated by the contactless card based on the authentication challenge.

10. The secure authentication system of claim 8, wherein the user device is further configured to write the authentication challenge in APDU format into a NDEF file stored in the contactless card.

11. The secure authentication system of claim 8, wherein the user device is further configured to generate the authentication challenge.

12. The secure authentication system of claim 8, wherein the user device is further configured to determine whether the user device is capable of writing the authentication challenge into the contactless card in APDU format.

13. The secure authentication system of claim 12, wherein the authentication challenge is set as a default value of zero when the user device is determined not to be capable of writing the authentication challenge into the contactless card in the APDU format.

14. The secure authentication system of claim 8, wherein the user device is further configured to receive from the server a notification indicating that the authentication challenge is validated.

15. The secure authentication system of claim 8, wherein the encrypted MAC cryptogram is received from the contactless card through a near field communication (NFC).

16. A contactless card comprising:
a memory containing a counter value and a card key;
a communication interface; and
a processor in communication with the memory and communication interface,
wherein the processors is configured to:
receive an authentication challenge from a user device when the communication interface is within a range of a communication field of the user device,
create an encrypted MAC cryptogram using the card key, the authentication challenge, and the counter value, and
transmit the encrypted MAC cryptogram, via the communication interface, to the user device.

17. The contactless card of claim 16, wherein the authentication challenge is set as a default value of zero when the user device is determined not to be capable of writing the authentication challenge to the contactless in APDU format.

18. The contactless card of claim 16, wherein the encrypted MAC cryptogram is encrypted using one or more cryptographic algorithms comprising at least one of a symmetric encryption algorithm, an HMAC algorithm, and a CMAC algorithm.

19. The contactless card of claim 16, wherein the processor is configured to update the counter value when the communication interface is within the range of the communication field of the user device, the counter value comprising a one-time passcode.

20. The contactless card of claim 16, wherein the card key is limited to a predetermined number of uses.
